(19) United States
(12) Patent Application Publication
(10) Pub. No.: US 2022/0407150 A1
(43) Pub. Date: Dec. 22, 2022

(54) ZINC-AIR CHARGING SYSTEM AND ASSOCIATED SOFTWARE AND DATA STRATEGY

(71) Applicant: Revolution Power Inc., Seattle, WA (US)

(72) Inventors: Daniel Scott Davidson, Mill Creek, WA (US); Luke David Springer, Battle Ground, WA (US); George Smilov, Bellingham, WA (US); Daniel Mark Stevens, Seattle, WA (US); Keith William Kirkwood, Bainbridge Island, WA (US); David Victor Clark, Tacoma, WA (US); James Bradley Downar, III, Seattle, WA (US); Daniel Wainwright Shaw, Seattle, WA (US)

(21) Appl. No.: 17/845,831

(22) Filed: Jun. 21, 2022

Related U.S. Application Data
(60) Provisional application No. 63/212,974, filed on Jun. 21, 2021.

(51) Int. Cl. H01M 12/06; H01M 12/02; H01M 50/216; H01M 50/51; H01M 50/253; H02J 7/34

(52) U.S. Cl. CPC H01M 12/06; H01M 12/02; H01M 50/216; H01M 50/51; H01M 50/253; H02J 7/342

(57) ABSTRACT

A zinc-air charger having a case defining a plurality of pass core vents, and an internal case cavity; a plurality of zinc-air cells that are electrically coupled and disposed within the internal case cavity; a coupling plug configured to couple with and provide electrical power generated by the plurality of zinc-air cells to a device that is separate from the zinc-air charger; and a system configured to: output electrical power generated by the plurality of zinc-air cells to the device; identify a state of the plurality of zinc-air cells, determine, based at least in part on the identified state of the plurality of zinc-air cells, that one or more of the plurality of zinc-air cells are air-starved, and in response to determining that the one or more of the plurality of zinc-air cells are air-starved, generate a power cut-off for a period of time that ceases electrical power output to the device.

### CROSS-REFERENCE TO RELATED APPLICATIONS

This application is a non-provisional of and claims the benefit of U.S. Provisional Application No. 63/212,974, filed Jun. 21, 2021, entitled “ZINC AIR CHARGING SYSTEM AND ASSOCIATED SOFTWARE AND DATA STRATEGY” with attorney docket number 0104980-007PR0. This application is hereby incorporated herein by reference in its entirety and for all purposes.

This application is also related to patent application Ser. No. 17/313,600, filed May 6, 2021, entitled “ZINC-AIR BATTERY SYSTEMS AND METHODS,” with attorney docket number 0104980-004US0. This application is hereby incorporated herein by reference in its entirety and for all purposes.

This application is also related to patent application Ser. No. 17/313,644, filed May 6, 2021, entitled “ZINC-AIR BATTERY COMPOSITIONS AND METHODS,” with attorney docket number 0104980-005US0. This application is hereby incorporated herein by reference in its entirety and for all purposes.

### BRIEF DESCRIPTION OF THE DRAWINGS

FIG. 1 illustrates one example embodiment of a charger, which can be used to power a smartphone by plugging a cable into the charger and into the smartphone such that electrical power stored in the charger is provided to the smartphone via the cable.

FIG. 2 illustrates a perspective view of internal components of a charger 100 including the cells 240 and PCBA 230.

FIG. 3 illustrates an exploded view of a charger.

FIG. 4a illustrates a cross-sectional axis X, which illustrates the cross section of the charger shown in FIG. 4b.

FIG. 5 is a close-up view of the circled portion of FIG. 4b.

FIGS. 6 and 7 illustrate a method of constructing and packaging a charger in accordance with an example embodiment.

FIG. 8a illustrates a plurality of cells disposed in a welding fixture.

FIG. 8b illustrates conductive strips positioned on the respective cells of FIG. 8a.

FIG. 9a illustrates a holding fixture placed on the conductive strips and cells of FIG. 8b.

FIG. 9b illustrates the conductive strips spot welded to a side rim of the cells such that the conductive strips are coupled to the cells.

FIG. 10a illustrates a bend fixture placed over a given conductive strip and cell.

FIG. 10b illustrates the conductive strip bent into a vertical installation position.

FIG. 11 illustrates a PCBA disposed in a pack welding fixture.

FIG. 12 illustrates a plurality of cells with attached conductive strips disposed into the welding fixture.

FIG. 13 illustrates conductive strips coupled to an adjacent cell such that the cells are electrically coupled in series via the conductive strips.

FIG. 14 illustrates the second case portion placed over the welding fixture with the plurality of cells, conductive strips and PCBA and the second case portion pressed down to snap the cells into place in the second case portion.

FIG. 15 illustrates the welding fixture removed to form a finished portion of a charger with the plurality of cells, conductive strips and PCBA disposed in the second case portion.

FIGS. 16 and 17 illustrate a barrier assembly positioned into the first case portion.

FIG. 18 illustrates the first case portion with the barrier assembly coupled with the second case portion having the plurality of cells, conductive strips and PCBA.

FIG. 19 illustrates the charger rotated to expose screw bosses on the face of the second case portion and screws being installed in the charger to further join the first and second case portions together.

FIG. 20 illustrates a label disposed on a face of the second case portion.

FIG. 21 illustrates an assembled charger vacuum packaged and/or heat sealed in a package.

FIG. 22 illustrates an embodiment of a charger disposed in packaging.

FIG. 23 illustrates the charger of FIG. 22 removed from the packaging.

FIG. 24 illustrates a user scanning a QR code with a device which can direct the device to a website.

FIG. 25 illustrates one or more chargers involved in a consumer process in accordance with an embodiment.

FIG. 26 illustrates a first and second example step in the use of a charger.

FIG. 27 illustrates a third and fourth example step in the use of a charger.

FIG. 28 illustrates an example embodiment of a circuit to control electrical power from one or more batteries or cells.

FIG. 29 illustrates an example of a cut-off method.

FIG. 30a illustrates an example embodiment of a charger where a circuit is disposed within a charger.

FIG. 30b illustrates an example embodiment where a circuit is disposed within a cable that is coupled to the charger.

FIG. 31a illustrates an example embodiment of a charger where a circuit is disposed within the footprint of a charger.

FIG. 31b illustrates an example embodiment where a circuit is disposed in a connector of the cable.

FIG. 31c illustrates an embodiment where the circuit 3010 is disposed in-line within the cable 140.

FIG. 32a illustrates an embodiment having six cells disposed in series.

FIG. 32b illustrates another example embodiment having six cells in a configuration where a first and second set of three cells are in series with the first and second sets of cells being in parallel.

FIG. 32c illustrates a further example embodiment having six cells disposed in parallel.

FIG. 33 illustrates an example embodiment of a charger that comprises a battery set having six cells in series and coupled to a protection diode and a regulator in series.

FIG. 34 illustrates a plurality of different embodiments of chargers having different numbers and configurations of cells and different types of connectors.

FIG. 35 illustrates an example of a zinc-air battery cell assembly having an anode and cathode can that define a cavity with anode and cathode materials disposed within the cavity.

FIG. 36 illustrates a cross-sectional view of an example of an air cathode assembly in accordance with one embodiment, which includes a first conductive layer, a grid disposed in a second air cathode layer and a third separator layer.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

In various embodiments, a zinc-air battery system can comprise a Printed Circuit Board Assembly (PCBA) with USB-C (Universal Serial Bus) connector on-board, a printed back label with Quick Response (QR) code to connect to a software system, encased in a brandable, puncture-proof, peel away package.

One example of a zinc-air charging system can comprise, consist essentially of, or consist of one or more of the following components: a plurality of zinc-air battery cells in series; a case top/bottom; a PCBA; and a cable. These can be configured in various embodiments to create different form-factors, charging profiles, output, etc. One example embodiment assembles the cells, case and PCBA together in one unit and only requires an off-the-shelf cord to complete the charger system.

Some embodiments remove the PCBA from the energy card and place it in the cable and the consumer can keep the custom cable for reuse. Also, where the circuit is resident in the cable, in various embodiments, the energy card can be placed in the home recycle bin in many U.S. jurisdictions. In various embodiments, energy cards can be a replaceable energy source/battery that can be purchased individually or in packs such as packs of 10, 20, 50, etc.

By integrating charger hardware with software, in various embodiments an energy and data platform can be generated to drive operational efficiencies, sell-through, and customer acquisition—extending the value of various charger/battery/energy solutions by adding software-delivered capabilities. In one example case of portable chargers, after scanning an identifier (e.g., QR code) to connect to software, one or more of the following can be enabled in some examples.

Smart Subscriptions: Once an identifier is scanned, it can be possible to determine that the charger is being used and a unique ID of the charger can be associated with a status of “being used.” A unique charger card ID can be linked with a subscription owner profile to determine how many charger cards the subscription owner has used and how many charger cards the subscription owner has left. The subscription owner in some examples can set a toggle in a subscription system such that a charger card vendor will automatically send the subscription owner X chargers when the subscription owner only has Y chargers in reserve.

In some embodiments, users can be incentivized to return, reuse and/or recycle chargers (e.g., via a web or smartphone app, or the like). In some embodiments, users can donate chargers (e.g., send X number of chargers to users suffering a natural disaster, to a refugee camp, to Doctors Without Borders missions, to a first responder organization, etc.). In some embodiments, users can share in social media (Insta/Snap/Face/Twit/etc.) the ways that the user's charger/energy card is being used.

Advertising/Promotion/Brand-Activation: In some embodiments, brands can customize the packaging associated with a charger or energy card as well as the software to provide a digital activation component to register, buy, learn, enter sweepstakes, etc. The some or all of such an integrated system, hardware and/or software, can be a customizable experiential marketing platform in various examples.

Transact: In some embodiments, users and/or vendors can share and/or sell chargers. For example, a web or smartphone app can allow such transactions to be settled. In some embodiments, this can allow Uber/Lyft drivers, hotel concierge, college students, girl scouts, and others to act as person-to-person distributors at the point of need.

Integration for Military, FEMA, etc.: Various embodiments can be configured such that the system easily integrates into existing systems via an API or as a standalone web or smartphone app. Some examples can include software that is customizable to read data directly off of a portable device or smartphone (e.g., user coordinates, device status, orientation, etc.) as well as take user input (e.g., text, voice, manual input such as Red/Green/Blue status, etc.) This can be desirable in some examples, including when supporting military ATAK software typically used on smartphones and tablets as well as first-responder communications systems.

Some embodiments can include a 5-cell charger system with battery cells welded in series, managed by a custom-engineered PCBA, with a Teflon cover to prevent or reduce cell leakage failure to reach the surface of the charger. In some embodiments, portions of the charger can be contained in a plastic injection molded case allowing for ample air ingress and space between cell and case surface, with a custom label incorporating a QR code to connect to software on the back/bottom side, encased in a vacuum-packaged bag. For some embodiments of a vacuum packaged film, it can be desirable for there to be a very slight amount of air ingress and gas escapability—not too much, not too little, just the right amount of both.

In various embodiments, zinc-air based charging systems can be desirable compared to other types of battery systems such as lithium-ion packs that do not maintain charge for long durations (e.g., lithium-ion packs can self-drain in less than a month) and such lithium-ion batteries can require a user to charge them prior to use.

In various embodiments, a charger can comprise, consist essentially of, or consist of one or more battery, a PCBA, USB-C port, etc. A “battery” in some examples can be defined as five cells in parallel in a case, packaged, but without a PCBA and/or USB-C. In some examples, a “battery” alone could be “docked” into a charger or device with the PCBA and USB-C, but a “charger” in some examples can require all three to function. When the cells are combined in series, with the PCBA and USB-C in one unit, in various embodiments this can define a “charger” rather than a “battery.”

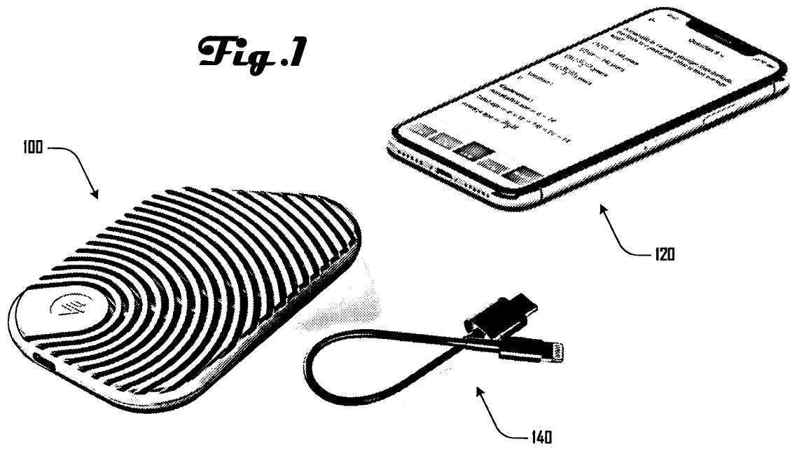

As discussed in more detail herein, in various embodiments, a charger can be used to provide electric power to various suitable devices in various suitable ways. For example, FIG. 1 illustrates one example embodiment of a charger 100, which can be used to power a smartphone 120 by plugging a cable 140 into the charger 100 and into the smartphone 120 such that electrical power stored in the charger 100 is provided to the smartphone 120 via the cable 140.

In various embodiments, chargers 100 designed with one or more zinc-air cells are one-time use, and always ready to provide a charge to a device. Applications of a charger can include a user charging a device (e.g., cellphone, laptop, tablet, other electronics) in an emergency or other situation where grid power is unavailable; a user at an event purchasing a charger 100 and charging and disposing of the charger 100 in a recycling receptacle.

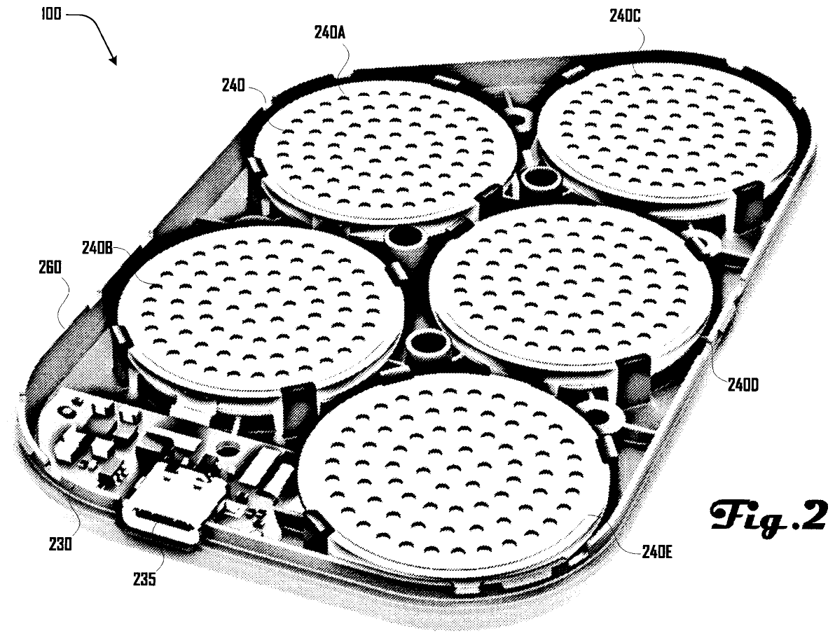

Turning to FIGS. 2, 3, 4a, 4b and 5, an embodiment of a charger 100 is illustrated that comprises a first case portion 210 with pass core vents 215, a barrier assembly 220, a PCBA 230 with coupling plug 235, a plurality of cells 240, a plurality of conductive strips 250, a second case portion 260, a plurality of screws 270 and a label 280. The first and second case portions 210, 260 can be coupled together to define an internal case cavity, which can contain elements such as the barrier assembly 220, PCBA 230, coupling plug 235, plurality of cells 240, plurality of conductive strips 250, and the like.

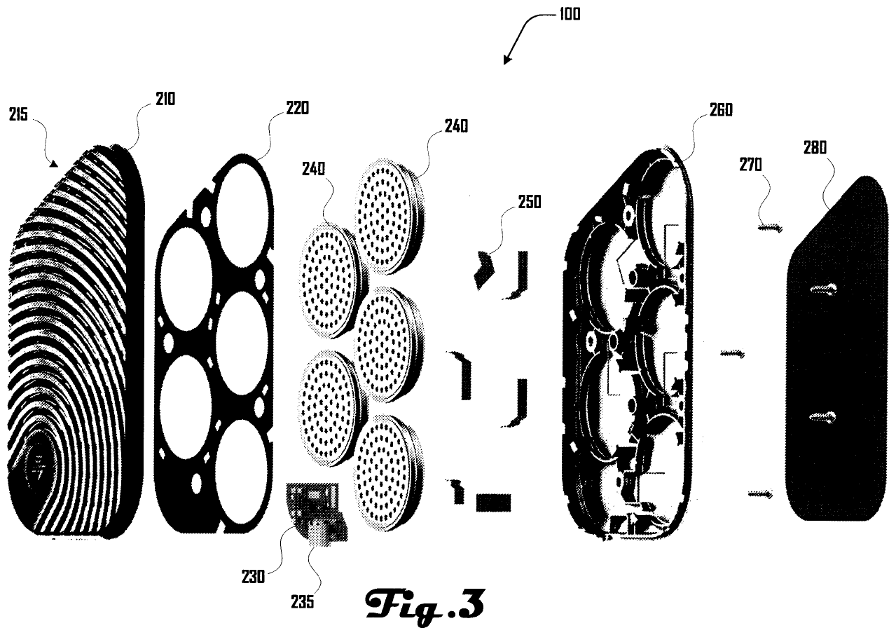

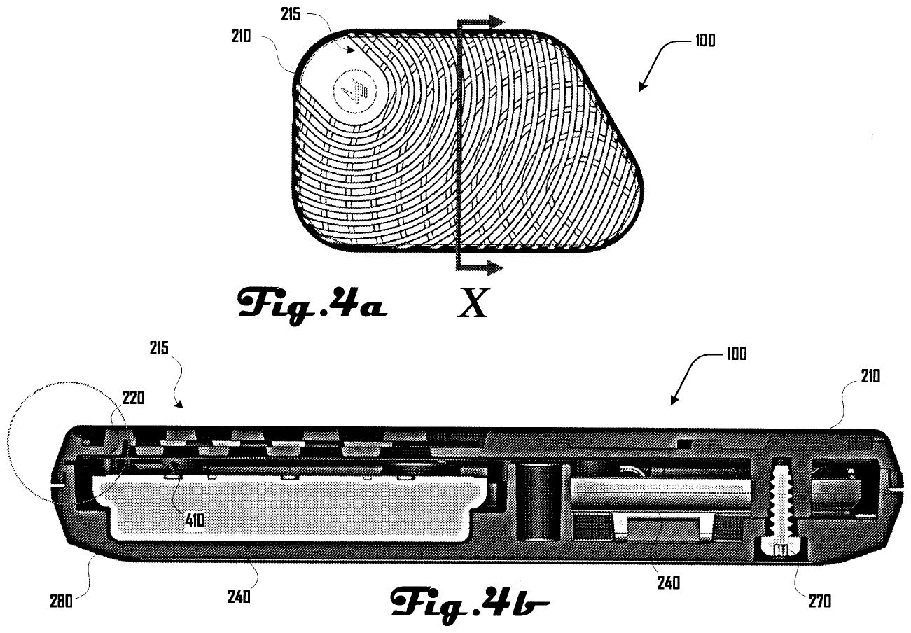

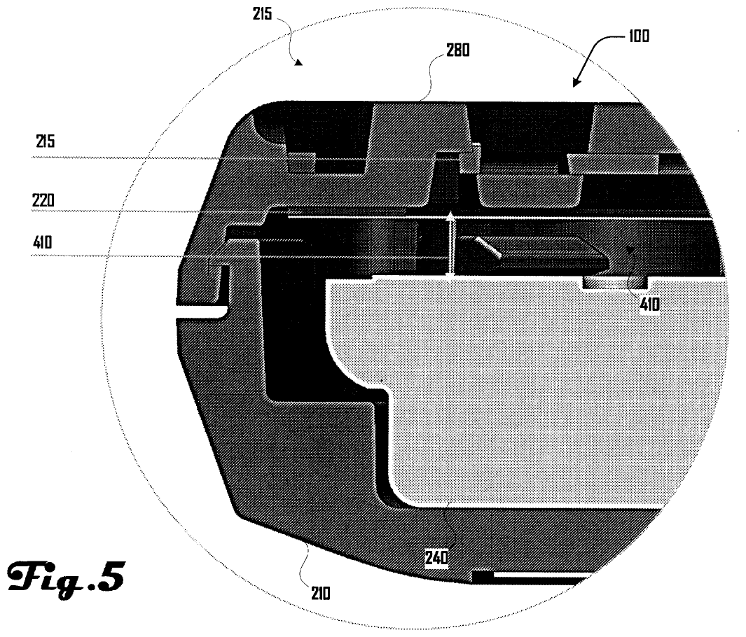

FIG. 2 illustrates a perspective view of internal components of a charger 100 including the cells 240 and PCBA 230. FIG. 3 illustrates an exploded view of a charger 100. FIG. 4a illustrates a cross-sectional axis X, which illustrates the cross section of the charger 100 shown in FIG. 4b. FIG. 5 is a close-up view of the circled portion of FIG. 4b. An air gap 410 within the charger 100 between the cells 240 and barrier assembly 220 and/or first case portion 210 is shown in FIGS. 4b and 5.

In various embodiments, the first and second case portions 210, 260 can be made of any suitable material such as plastic, metal, fiber-based, cardboard, wood, or the like. The first case portion 210 can define a plurality of pass core vents 215, which can be spaces, holes or cavities defined by first case portion 210 that allow air, and the like, to pass through the first case portion 210 including from external to the charger 100 to an internal portion of the charger 100 such as within the air gap 410 and vice versa. In some embodiments, pass core vents 215 can provide air access to the cells 240 while limiting visibility of the openings into the first case portion 210. For example, pass core vents in some embodiments can be difficult to see when looking at the charger 100 head on and may only be revealed when tipping the charger 100 off-axis.

In some embodiments, the barrier assembly 220 can comprise a planar hydrophobic label that can allow gas to pass in and out of the charger 100, but prevent liquid from coming into charger 100 and liquid (e.g., KOH and electrolyte of the cells 240) from leaking out of the charger 100. In some embodiments, the barrier assembly 220 can be constructed of a barrier-grade Teflon (polytetrafluoroethylene) with a high oxygen transmission rate and laminated with a low surface energy adhesive. In some examples, the barrier assembly 220 can comprise a stiffening layer that has a compatible adhesive to aid assembly. In various embodiments, the barrier assembly 220 can disposed within the internal case cavity defined by the case between and directly adjacent to the first case portion and the set of cells 240, the barrier assembly comprising a planar hydrophobic sheet of polytetrafluoroethylene that allows gas to pass through the barrier assembly in and out of the internal case cavity to and from zinc-air cells 240, but preventing external liquid from coming into contact with the zinc-air cells 240 and preventing liquid of the zinc-air cells 240 from leaking out of the internal case cavity.

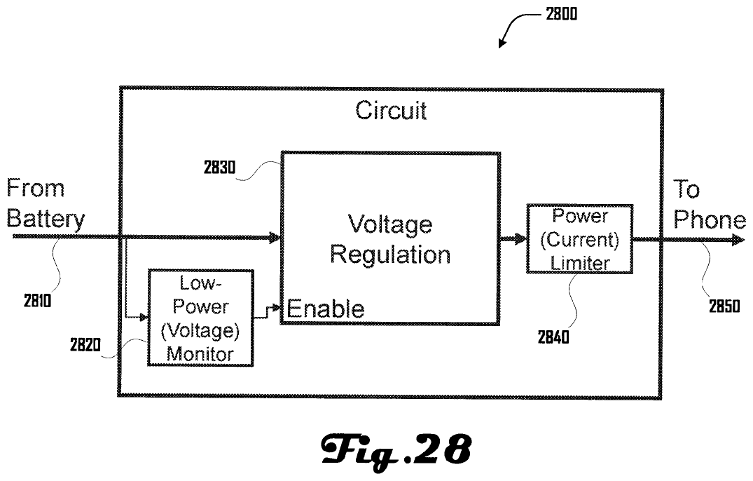

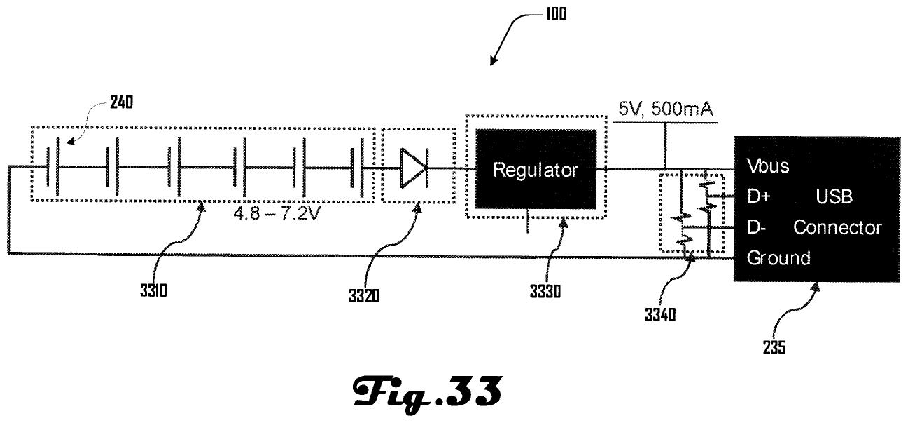

The PCBA 230 can comprise any suitable components and have any suitable level of complexity in accordance with various embodiments, including components suitable to perform or execute at least some of the methods described herein. For example, in some embodiments, the PCBA 230 can comprise one or more of a circuit board, resistor, transistor, capacitors, inductors, transformers, diode, sensor, firmware, processor, memory, coupling plug 235, wireless communication unit (e.g., Bluetooth, NFC, Wi-Fi), wireless power communication unit, GPS system, and the like. Further examples of elements that can be part of a PCBA 230 are discussed herein including elements shown in FIGS. 28 and 33 and related disclosure. Additionally, it should be clear that any suitable computing device can be used in further embodiments and that use of the term Printed Circuit Board Assembly (PCBA) should not be construed to be limiting.

The coupling plug 235 can comprise various suitable elements capable of coupling with other elements (e.g., cable 140) and communicating electrical power and/or data. For example, in some embodiments, the coupling plug 235 can comprise a USB-A, USB-C, Micro-B USB, or other suitable element. In various embodiments, at least a portion of the coupling plug 235 can be exposed external to the internal case cavity to allow for a cable 140 or other element to couple with the coupling plug 235. Such a coupling plug 235 can be a “male” or “female” coupling plug in various embodiments, so the examples herein should not be construed to be limiting.

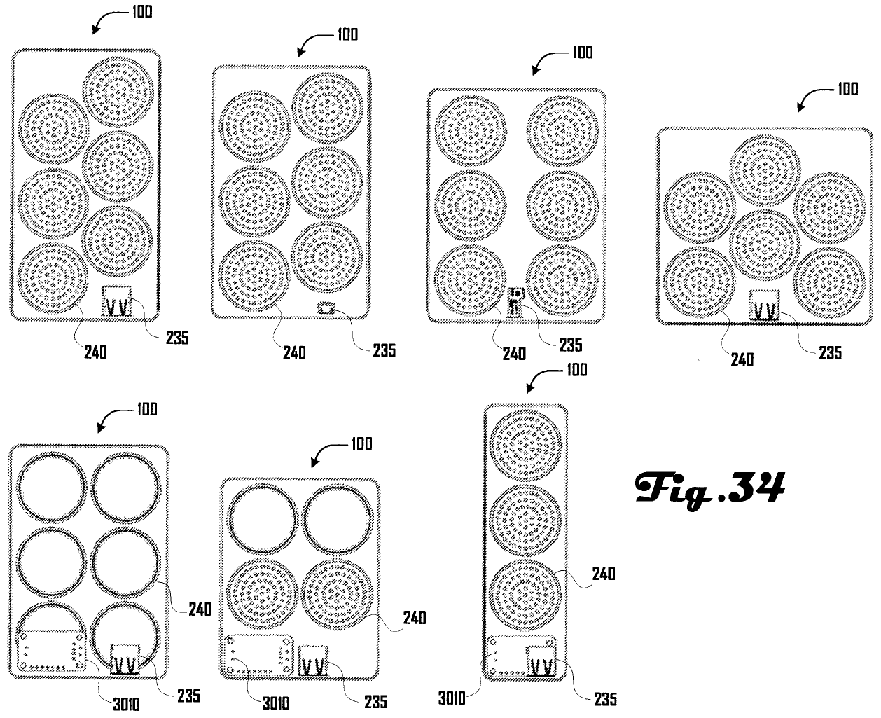

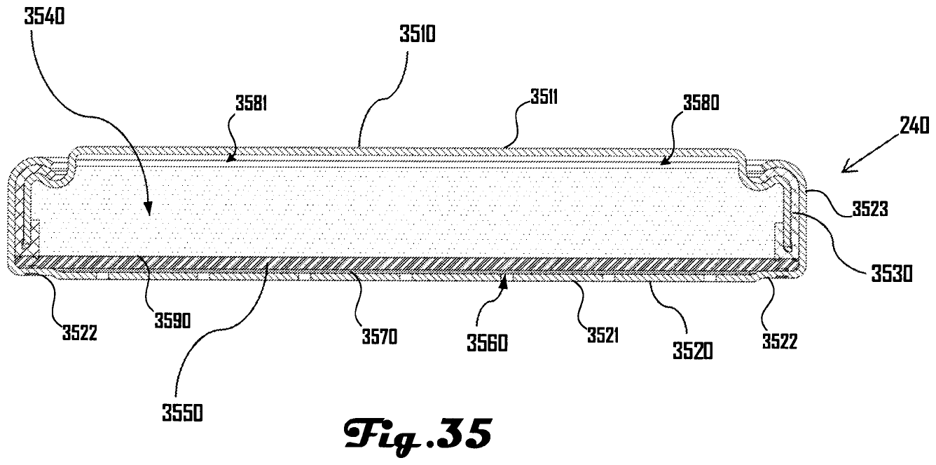

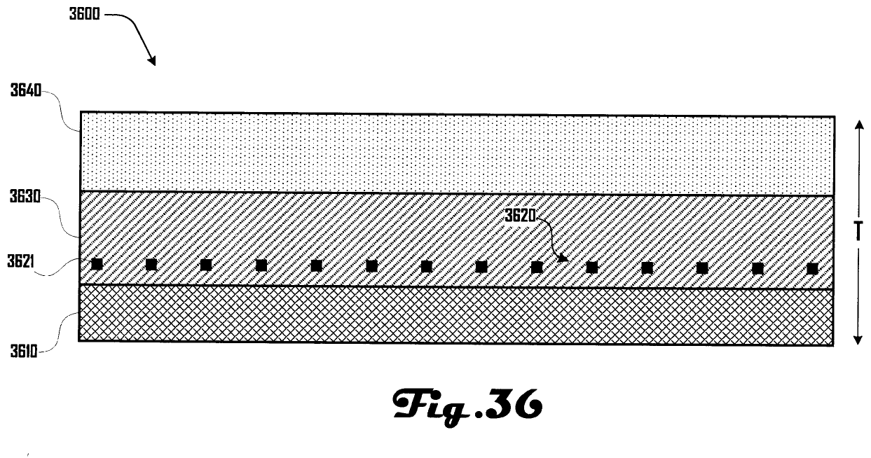

In various embodiments, the cells 240 can comprise zinc-air button cell batteries, with examples of such zinc-air batteries shown in FIGS. 35 and 36 and discussed in more detail herein and in patent application Ser. Nos. 17/313,600 and 17/313,644 filed May 6, 2021, which are cited above and incorporated by reference herein. As shown in the examples of FIGS. 2 and 3, a charger 100 can comprise, consist essentially of or consist of five cells 240 disposed in a common plane with the five cells 240 disposed in two columns of two and three cells 240 respectively, with a central diameter of the cells 240A, 240B in the two-column of cells 240 being aligned with spaces between respective cells 240C, 240D, 240E in the three-column of cells 240, and with a central diameter of a middle cell 240D of the three-column of cells being aligned with a space between the cells 240A, 240B of the two-column of cells 240. While FIGS. 2 and 3 illustrate one example of a charger 100 having no more or no less than five cells 240 in the example configuration discussed above, this should not be construed as limiting and further embodiments can have any suitable number of cells 240 of any suitable type and in any suitable configuration. For example, FIG. 34 illustrates further examples of chargers 100 with different numbers of cells 240 in different configurations in accordance with further embodiments. In further embodiments, a charger 100 can have any suitable number of cells 240, including 1, 2, 3, 4, 5, 6, 7, 8, 9, 10, 11, 12, 13, 14, 15, 20, 25, 50, 100, 500, 1000, or the like.

In various embodiments, the conductive strips 250 can comprise various suitable materials such as metal, with the conductive strips 250 comprising, consisting essentially of or consisting of nickel in some examples. In various embodiments, the first and second case portions 210, 260 can be coupled together in various suitable ways including via the screws 270 as shown in the example of FIGS. 2, 3, 4b with further examples including coupling via a friction fit, adhesive, weld, slot, rim, or the like, in further embodiments.

In various embodiments, an internal air gap 410 can be provided to provide for function of the cells 240 (e.g., zinc-air cells 240). Testing has indicated that in some embodiments, an air gap minimum of 1.5 mm was required in some examples to provide reliable device function. Some embodiments can include an air gap 410 of 1.4-1.6 mm, 1.3-1.7 mm, 1.2-1.8 mm, 1.1-1.9 mm, 1.0-2.0 mm, and the like.

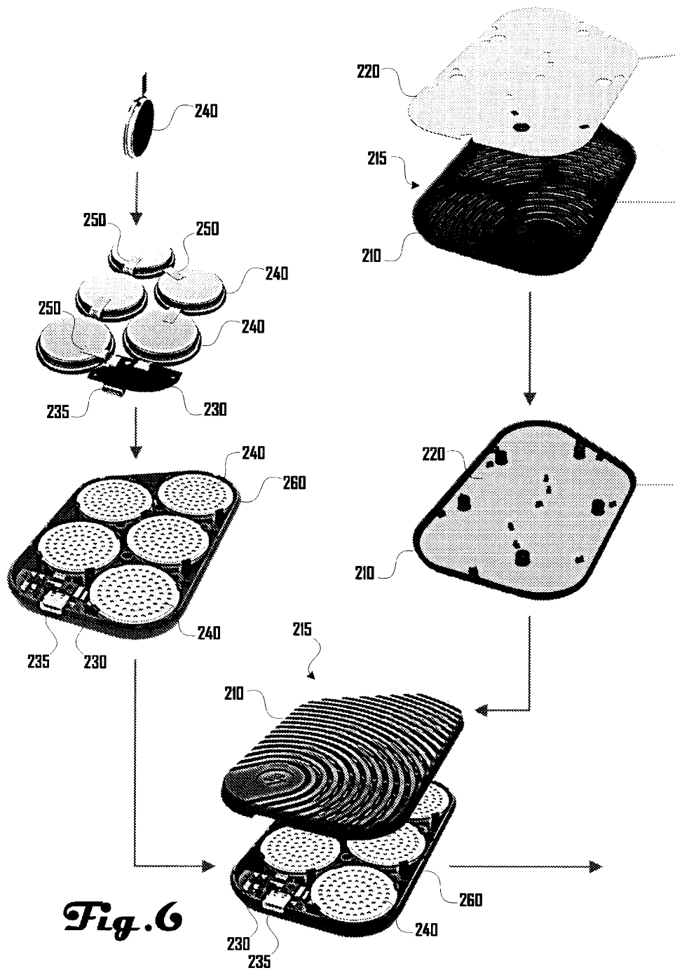

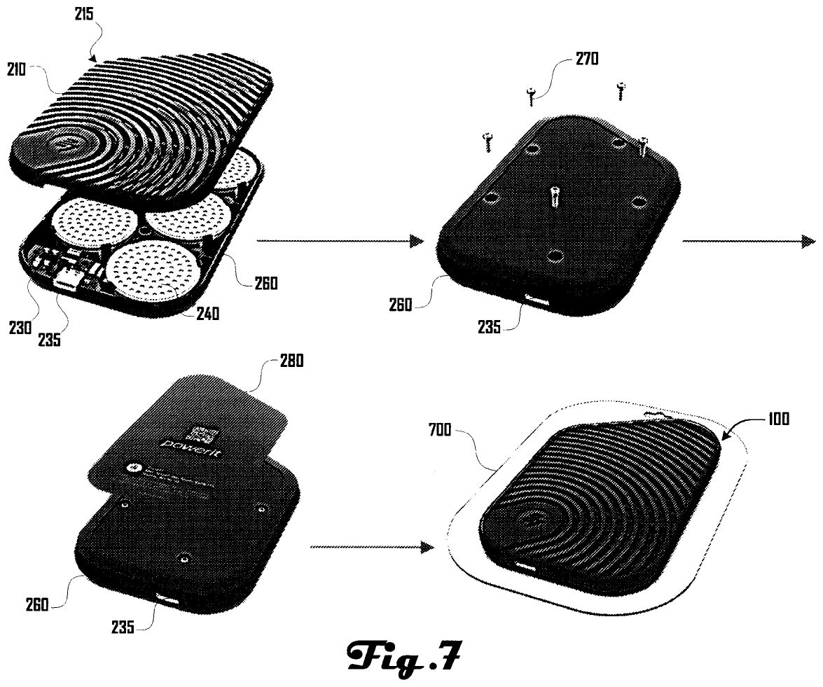

Turning to FIGS. 6 and 7, a method of constructing and packaging a charger 100 in accordance with an example embodiment is illustrated. For example, as shown in the top left of FIG. 6, a plurality of cells 240 can be assembled into a cell assembly along with a PCBA 230, which can be operably coupled via conductive strips 250. The cell assembly can be disposed in a second case portion 260 to generate a second case portion sub-assembly. As show on the top right of FIG. 6, a barrier assembly 220 (e.g., a Teflon sheet) can be disposed in a first case portion 210 to generate a first case portion sub-assembly. The first case portion sub-assembly and the second case portion sub-assembly can then be coupled together as shown on the bottom of FIG. 6 and top left of FIG. 7.

As shown in FIG. 7, a plurality of screws 270 can be used to further couple the first and second case portions 210, 260 together and a label 280 can be disposed on a face of the second case portion 260. The assembled charger 100 can then be vacuum packaged in a package 700 as discussed in more detail herein.

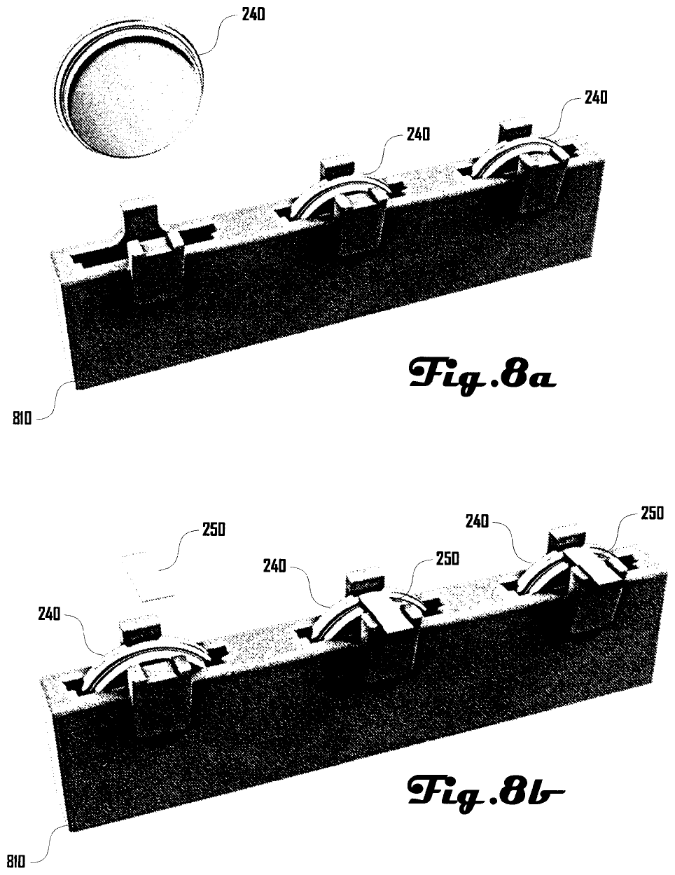

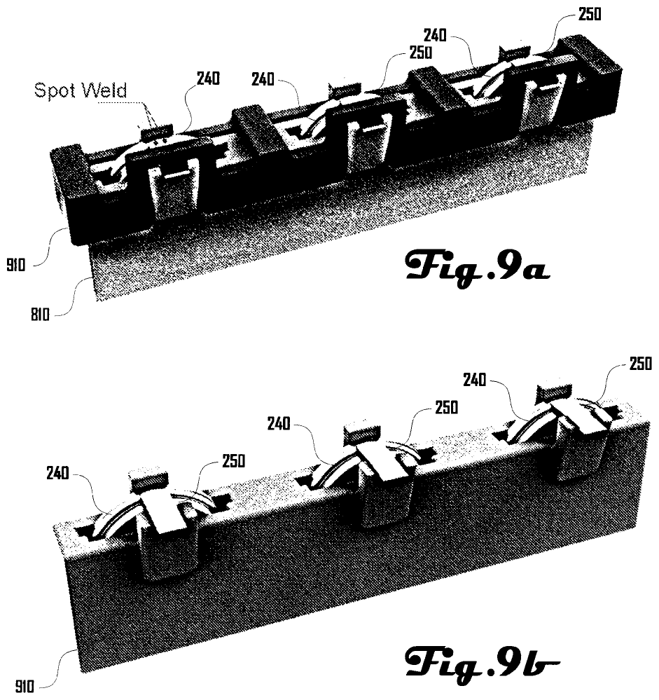

Turning to FIGS. 8a, 8b, 9a, 9b, 10a, 10b, 11, 12, 13, 14, 15, 16, 17, 18, 19, 20 and 21 a method of constructing and packaging a charger 100 in accordance with an example embodiment is illustrated. As shown in FIG. 8a, a plurality of cells 240 can be disposed in a welding fixture 810 and conductive strips 250 (e.g., nickel) can be positioned on the respective cells 240 as shown in FIG. 8b. As shown in FIG. 9a, a holding fixture 910 can be placed on the conductive strips 250 and cells 240 to hold the conductive strips 250 in place and the conductive strips 250 can be spot welded to a side rim of the cells 240 such that the conductive strips are coupled to the cells 240 as shown in FIG. 9b.

Any suitable number of spot welds can be applied (e.g., 1, 2, 3, 4 and the like) to couple a conductive strip 250 to a cell 240 and in further embodiments, any suitable coupling method can be used to couple conductive strips 250 to cells 240 (e.g., spot weld, laser weld, solder, clip etc.). Also, while the example of FIGS. 8a-9b illustrate a welding fixture 810 and holding fixture 910 configured for holding three cells 240, further embodiments can be configured to hold any suitable number of cells 240 (e.g., 1, 2, 3, 4, 5, 10, 15, 25, 50, and the like).

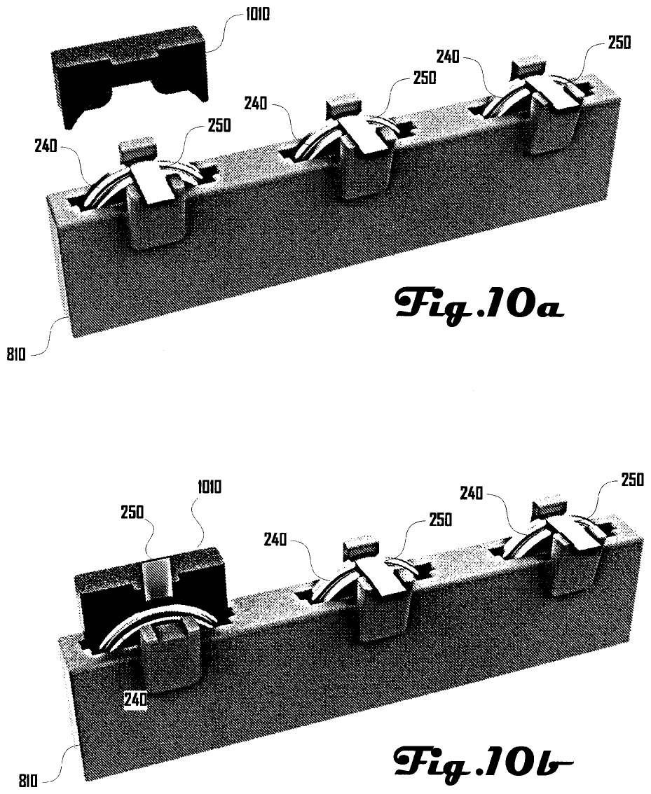

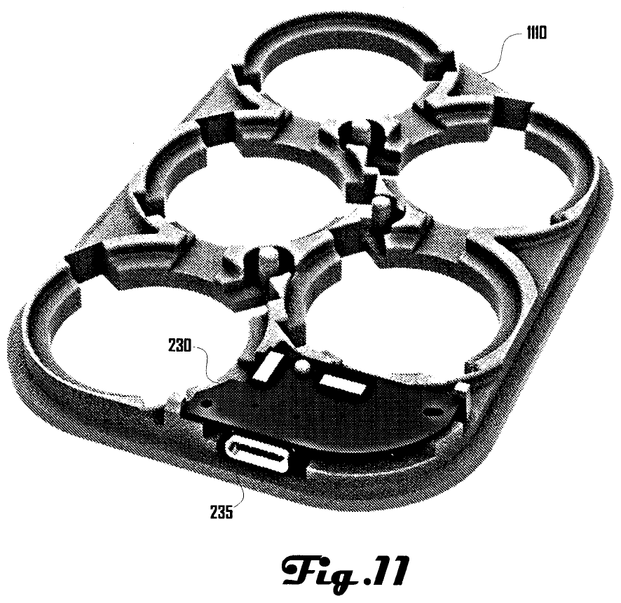

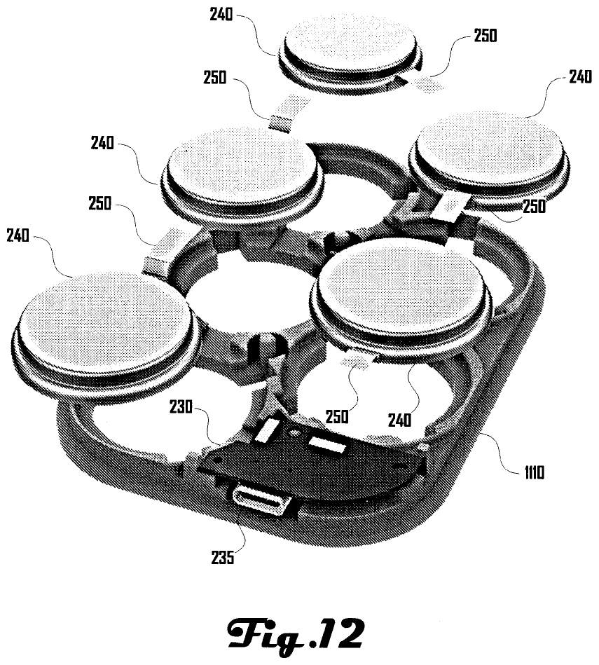

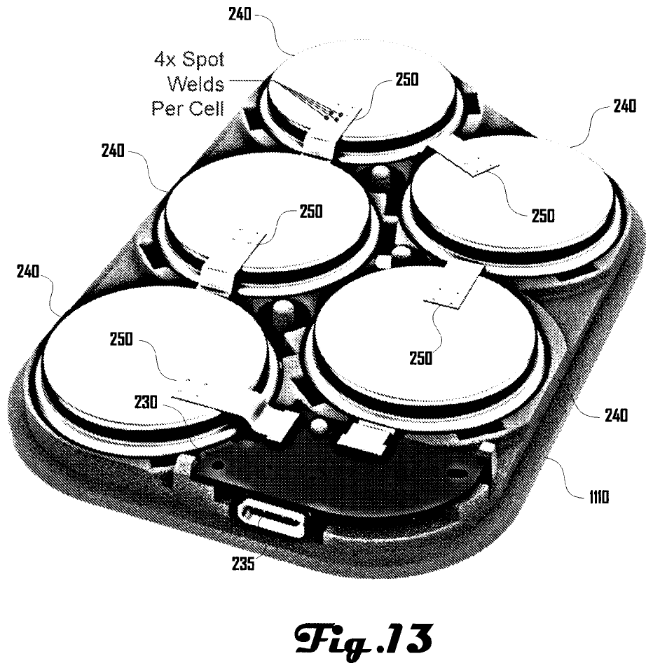

As shown in the example of FIG. 10a, a bend fixture 1010 can be placed over a given conductive strip 250 and cell 240 and the conductive strip 250 can be bent into a vertical installation position as shown in the example of FIG. 10b. As shown in FIG. 11, a PCBA 230 can be disposed in a pack welding fixture 1110 and as shown in FIG. 12, a plurality of cells 240 with attached conductive strips 250 can be disposed into the welding fixture 1110. As shown in FIG. 13, the conductive strips 250 can be coupled to an adjacent cell 240 (e.g., four spot welds per cell) such that the cells 240 are electrically coupled in series via the conductive strips 250. A conductive strip 250 can be soldered to the PCBA 230. Coupling of the conductive strips to the cells 240 and PCBA 230 can be done in various suitable ways including a spot weld, laser weld, solder, clip etc. In some embodiments, a function test can be performed on the cells 240 and PCBA 230 such as for open circuit voltage, charging and the like.

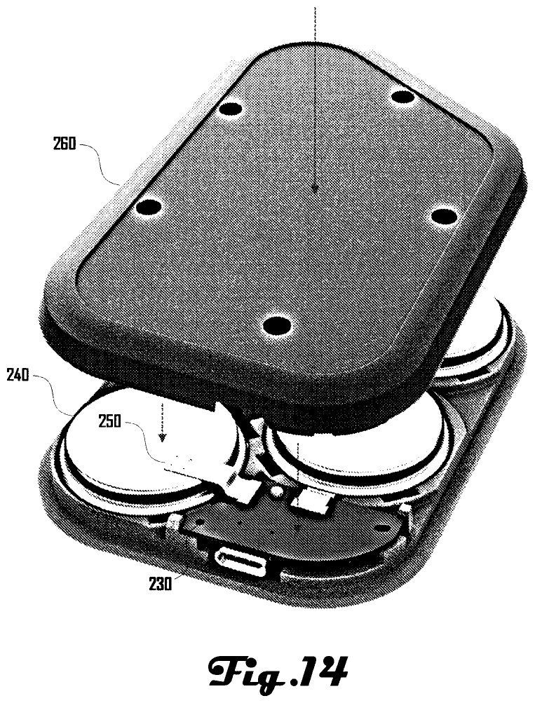

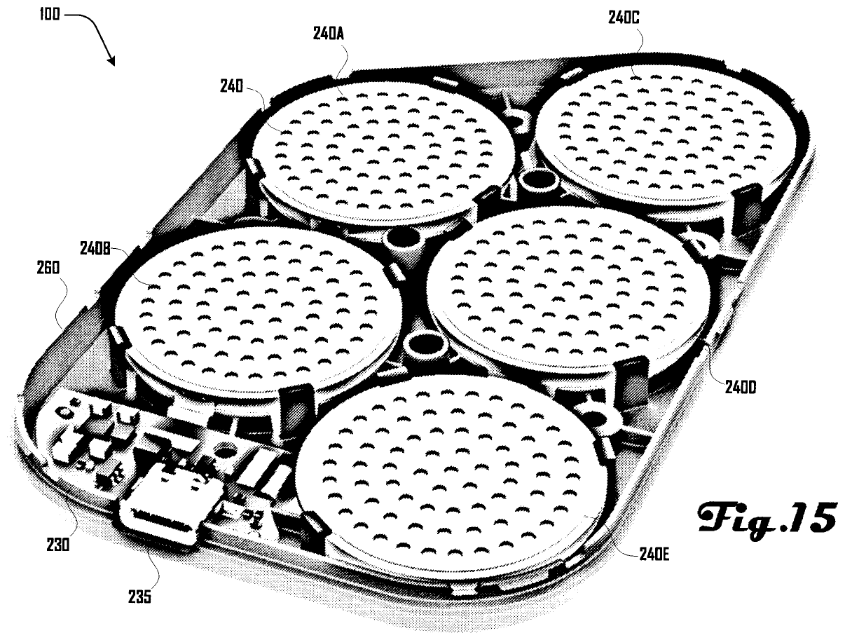

As shown in FIG. 14, the second case portion 260 can be placed over the welding fixture 1110 with the plurality of cells 240 conductive strips 250 and PCBA 230 and the second case portion 260 can be pressed down to snap the cells 240 into place in the second case portion 260. The welding fixture 1110 can be removed to form a finished portion of a charger as shown in FIG. 15 with the plurality of cells 240 conductive strips 250 and PCBA 230 disposed in the second case portion 260.

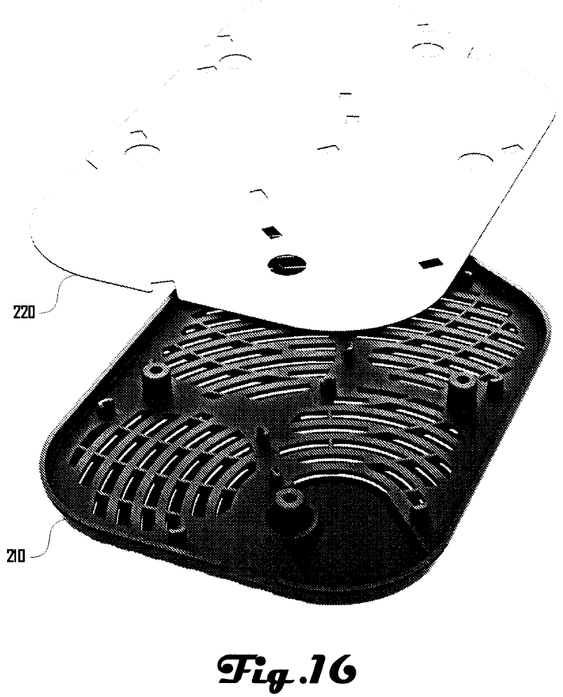

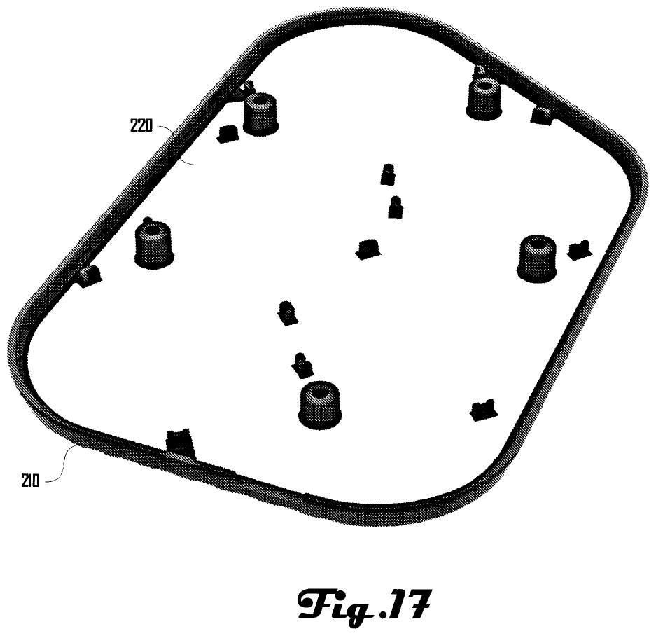

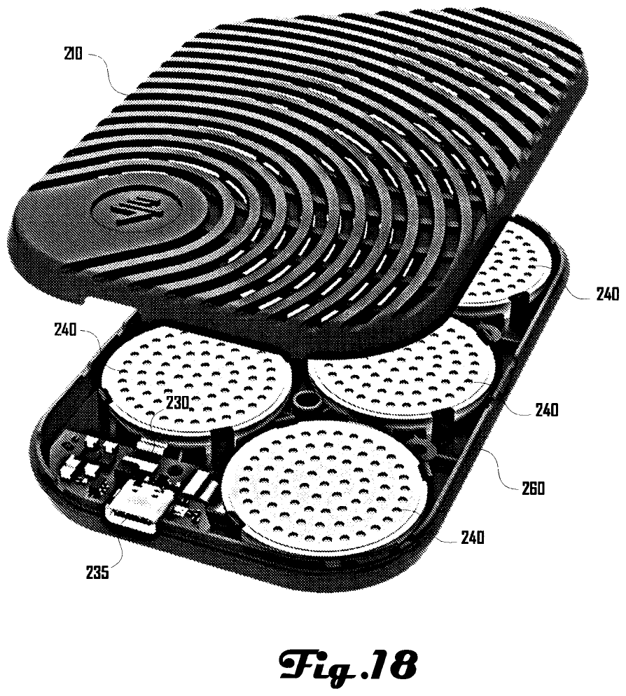

Turning to FIGS. 16 and 17, a barrier assembly 220 (e.g., Teflon sheet) can be positioned into the first case portion 210. As shown in FIG. 18, the first case portion 210 with the barrier assembly 220 can be coupled with the second case portion 260 having the plurality of cells 240, conductive strips 250, and PCBA 230. The first and second case portions 210, 260 can be pressed together to engage perimeter snaps to join the first and second case portions 210, 260 together.

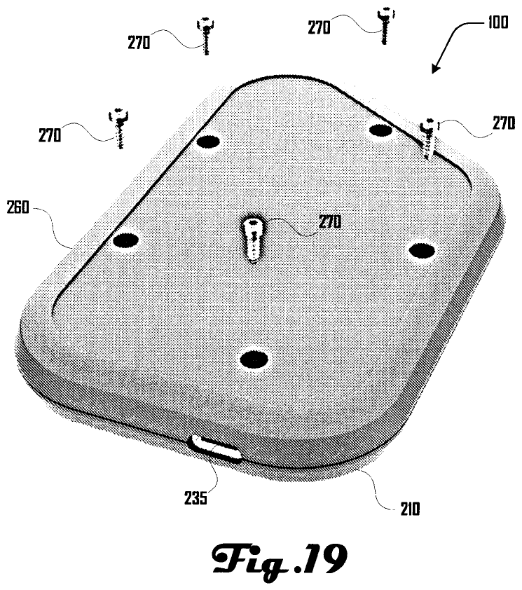

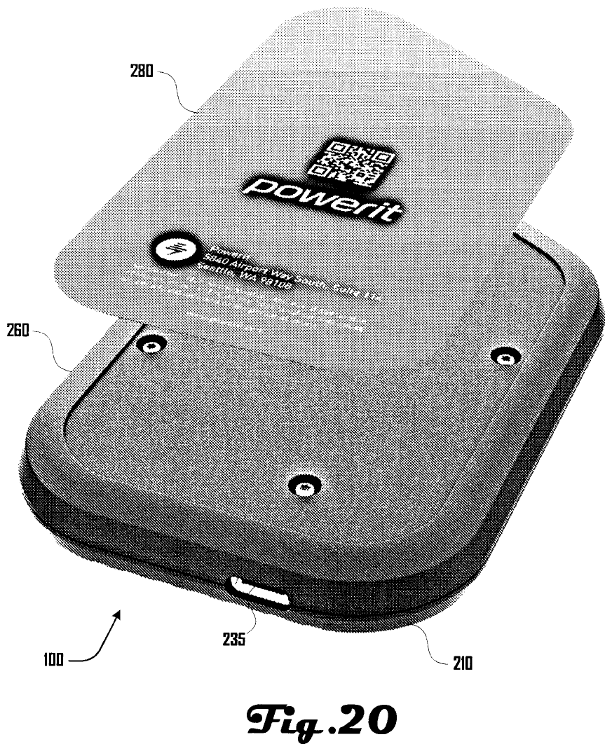

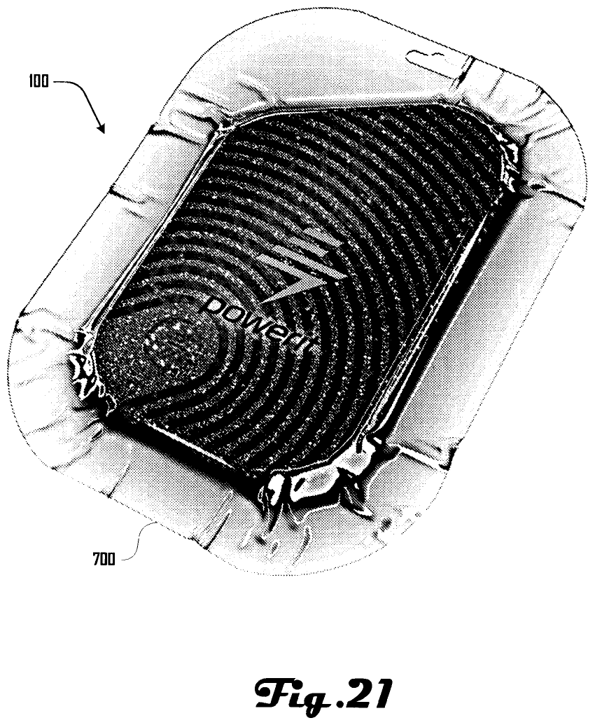

The charger can be rotated to expose screw bosses on the face of the second case portion 260 and screws 270 can be installed in the charger 100 as shown in FIG. 19 to further join the first and second case portions 210, 260 together. In some embodiments screw installation torque can be 0.2 N·m+/−0.06 N·m. A label 280 can be disposed on a face of the second case portion 260 as shown in FIG. 20. In some embodiments, the label 280 can be adhesive backed and can comprise polypropylene with acrylic adhesive and a matte finish overlaminate. The assembled charger 100 can then be vacuum packaged and/or heat sealed in a package 700 as shown in FIG. 21.

In various embodiments a charger 100 comprising zinc-air cells 240 can use ambient air (e.g., oxygen) as part of a cathode and can require access to air to generate electrical power. Accordingly, in some embodiments, the package 700 can comprise a heat sealed and/or shrink-wrap packaging material that can seal the charger 100 inside of a bag of desired oxygen and water transmission characteristics with a desired amount of air and/or water therein. For example, in some embodiments, the packaging 700 can be vacuum packaged such that substantially all air is removed from the packaging 700 with the packing providing for substantially no oxygen and water transmission into the packaging 700 such that zinc-air cells 240 of the charger 100 are not drained of power or lose effectiveness while stored in the packaging 700 before use of the charger 100. In some examples, the packaging 700 can comprise various suitable materials including HDPE, BOPP, PET layers, and the like.

In various embodiments, to activate the charger 100, a user can open the packaging 700 to expose the charger 100 to air and can plug a device into the charger 100 for the device to be charged. Such a method of packaging, storing and activating the charger with packaging 700 can be desirable by reducing/eliminating restrictions on geometry limitations of the charger 100 and/or packaging 700. In various examples, a label or the packaging 700 can be used as a markable item that can contain instructions, marketing information, advertisements, an identifier, a URL, a public key, a private key, and the like.

In some embodiments, the charger 100 can comprise an oxygen and/or waterproof label that seals the enclosure of the charger 100 from air by covering or sealing air vents 215 in the first case portion 210. Some embodiments can comprise a cover for an opening of the connector 235 to provide a seal of the charger 100 from the outside air that may enter through the connector 235. In some embodiments, such a cover can be separate from or a portion of the label. To activate the charger 100 the user can peel such a label and/or connector cover and plug a device into the charger 100 to provide power to the device. In some embodiments, a label and/or connector cover can comprise a polypropylene material with a repositionable acrylic-based adhesive.

In various embodiments, the purchase, use, disposal, recycling or trade of a charger 100 can be tracked. For example, a user can have a device (e.g., a smartphone, tablet computer, laptop, or the like) with an interface that allow the user to interact with a battery service (e.g., via a device app, via a web browser, or the like). For example, in some embodiments, such a battery service can be hosted on one or more virtual or non-virtual servers that are configured to interact with a plurality of user devices that are remote from such servers (e.g., via a network that comprises the Internet, Wi-Fi, a LAN, a WAN, a cellular network, or the like).

As discussed herein, in some embodiments, users can have a user account and various suitable uses or statuses associated with one or more chargers 100 can be associated with one or more user accounts.

In some embodiments, a keying system can be used to tie or associate a charger 100 to a person or user account based on serial number, unique identifier, or the like. Software in some examples (e.g., a battery service discussed above) can track user registration through various methods including via an identifier (e.g., QR code), a public key and/or private key. In various embodiments, the charger 100 and/or packaging 700 can be printed with a QR code, a public key and/or a private key that users can interact with (e.g., via a camera, text input, or the like).

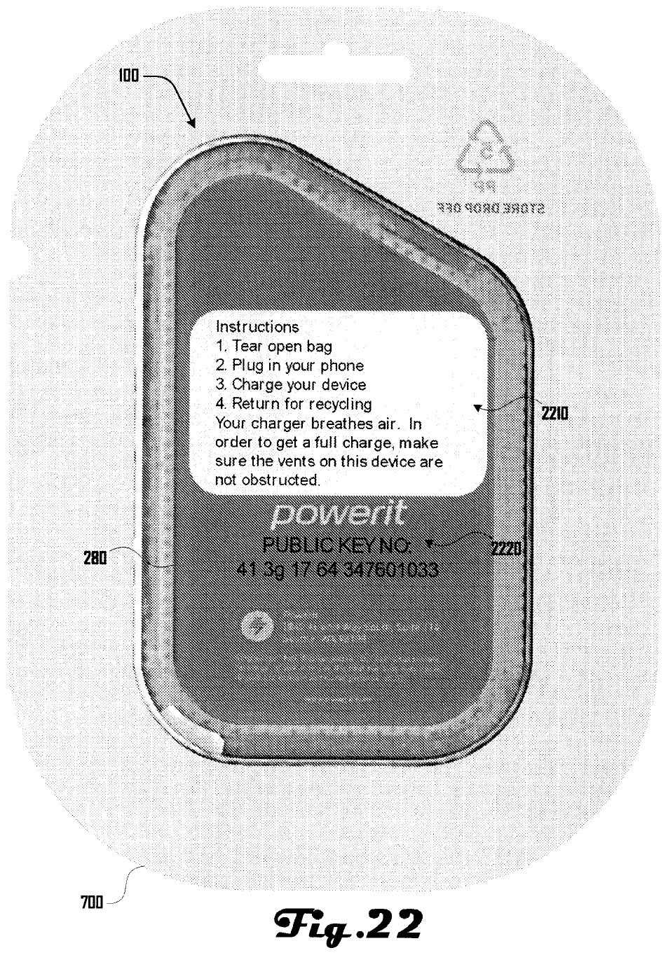

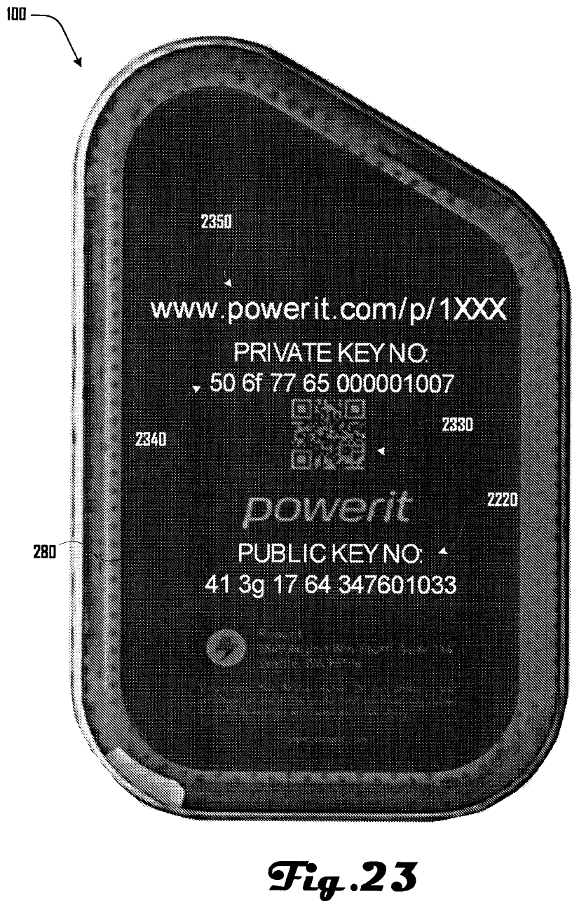

For example, FIG. 22 illustrates an embodiment of a charger 100 disposed in packaging 700 and FIG. 23 illustrates the charger 100 of FIG. 22 removed from the packaging 700. Specifically, FIG. 22 illustrates a charger 100 disposed in shrink-wrap packaging 700, which in various examples, requires a user to cut the packaging 700 in order to open the packaging 700. In other words, the packing 700 in some embodiments must be physically and permanently broken, deformed or destroyed in order to extract the charger 100 from within the packaging 700. In the example of FIG. 22, the packaging comprises a first packaging label 2210 that can comprise various instructions, advertisements and the like. Additionally, in various embodiments, the first packaging label 2210 can be opaque or otherwise capable of obscuring specific elements of the charger 100 as discussed herein. Such a packaging label 2210 can be printed directly on the packaging 700, a sticker disposed on an outer face of the packaging 700 or in some embodiments can be a sticker within the packaging 700 such as on an internal face of the packaging 700 or removably disposed on the charger label 280.

As also shown in FIG. 22, the charger 100 can have a public key 2220 printed on the label 280 of the charger 100. In various embodiments, the packaging 700 can be configured to be transparent or translucent or otherwise configured to allow the public key 2220 to be visible through the packaging 700.

Turning to FIG. 23, the charger 100 of FIG. 22 is shown after being removed from the packaging 700 (e.g., via a user tearing, cutting or ripping the packaging open 700). The public key 2220 that was visible through the packaging 700 remains visible, but removal of the packaging and the packaging label 2210 can expose elements such as a QR code 2330, private key 2340 and URL 2350, which may have been obscured by the packaging 700 and/or packaging label 2210.

In some embodiments, the public key 2220 can comprise a random, non-sequential code that is visible before opening the product packaging 700 that can be associated with and used to provide a user information on the product (e.g., location, origin of materials, material information, charger model number, charger capabilities, product literature, rewards programs, and the like).

In some embodiments, the private key 2340 can comprise a random number plus a sequential number for serialization. In various embodiments, the public key 2220 and/or private key 2340 can be a unique identifier associated with a given charger 100. In various examples, the private key can have value for the customer (e.g., rewards, prizes, concert tickets, free product, coupon, discount, or the like), which may provide the user with an incentive to register the charger 100 as discussed herein. Accordingly, obscuring the private key 2340 can be desirable so that only a user who purchases and opens the packaging 700 will be able to have access to the private key.

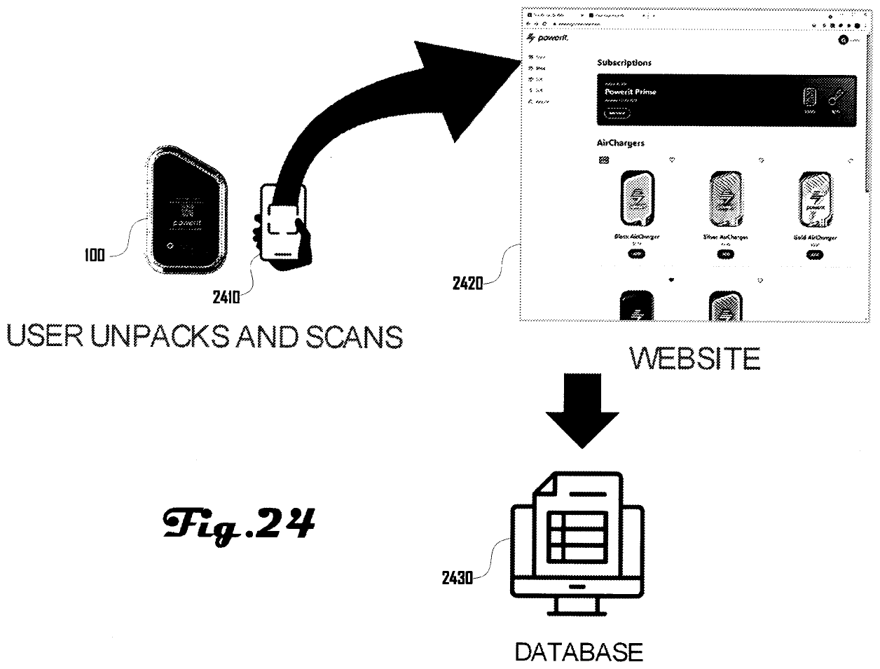

In some embodiments, the QR code 2330 can encode at least a portion of the private key 2340, the URL 2350, a different URL, the public key 2220, a unique identifier that may be different than one or both of the public or private keys 2220, 2340. For example, in the embodiment of FIG. 24, a user can unpack a charger 100 from packaging 700 to expose a QR code 2330 that was obscured when the charger 100 was packaged or otherwise not fully or partially unpacked. The user can then scan the QR code with a device 2410 (e.g., smartphone), which can direct the device to a website 2420 or in some embodiments open an app on the device 2410, or the like.

In some embodiments, the QR code can be associated with or encode a unique identifier (e.g., a private key 2340), which can be provided to or looked up via the website such that the unique identifier is associated with the browsing session. Additionally, in some embodiments, a session can be associated with a user account. For example, where user account information is stored at a browser or device app, opening the website or app can automatically generate a session associated with a given user account. In various embodiments, the unique identifier associated with the scanned QR code can be associated (e.g., automatically) with the user account, with such data being stored at a database 2430 (e.g., a virtual or non-virtual database, which may or may not be associated with or proximate to a server that hosts the website 2420). In some embodiments, a user can manually input a webpage URL (e.g., URL 2350) and/or manually input an identifier such as a private key 2340, or the like. Also, it should be clear that a QR code is only one example of a scannable element, with other embodiments using any other suitable scannable element such as a barcode or using OCR to identify text or other identifiers.

Associating an identifier of a charger 100 with a user account can be desirable because it can allow administrators to track the user and charger inventory of one or more users 100, which can be used to determine when a given user may need to purchase additional chargers 100 based on previous use habits, number of chargers 100 remaining/available in a user's inventory, or the like. Such a determination can be used to automatically order and send one or more chargers 100 to the user 100, provide an alert to the user, send the user a coupon, or the like. In some embodiments, tracking charger inventory and location of a plurality of users can provide for a system where users can trade, sell, barter or otherwise exchange chargers 100, which can be based on location.

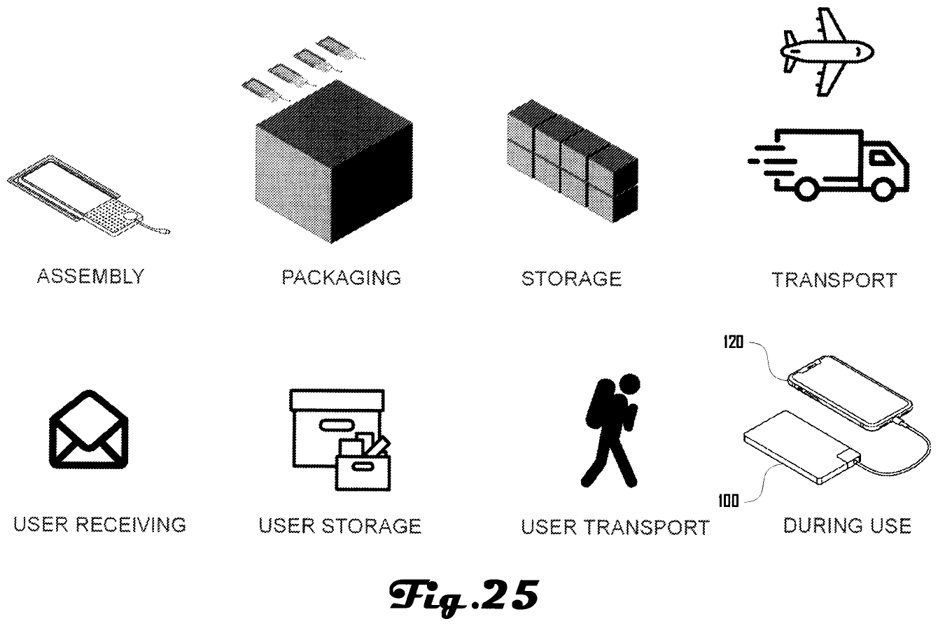

As shown in FIG. 25, chargers 100 can be involved in a consumer process, which can include assembly of one or more chargers 100, packing of the one or more chargers 100, storage of the one or more chargers 100, transport of at least one charger 100 to a user, user receipt of the at least one charger 100, user storage of the at least one charger 100, user transport of the at least one charger 100, and use of a charger 100 to provide electrical power to one or more user devices 110.

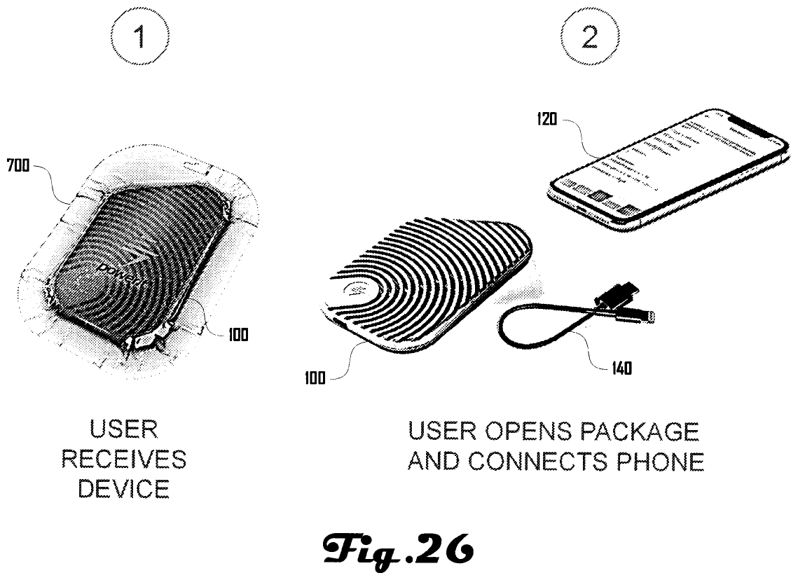

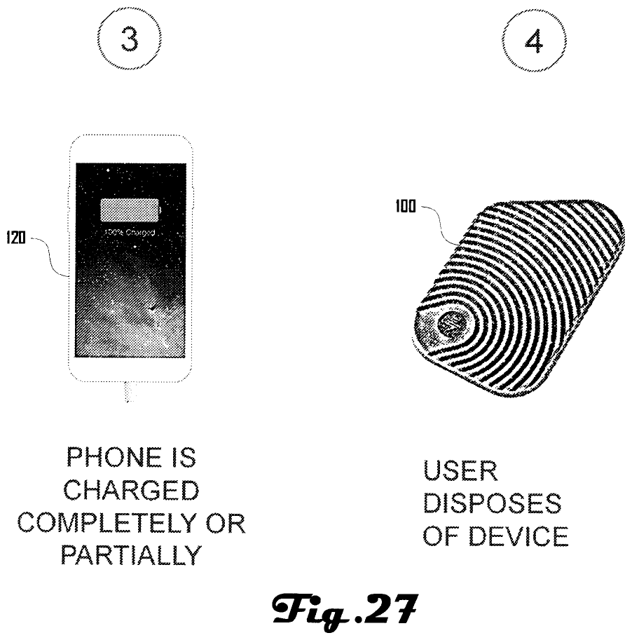

Use of a charger 100 can comprise a plurality of steps, including first, second, third and fourth example steps as shown in FIGS. 26 and 27. For example, a user can obtain a charger 100 disposed in packaging 700, which in various embodiments discussed herein can prevent or reduce an air-based chemical reaction in the charger 100 (e.g., oxygen interacting with a zinc-air battery) by preventing or substantially reducing the amount of air or other gas that can enter the packaging 700 and/or by eliminating or substantially eliminating such gas, vapor or liquid in the packaging 700 (e.g., via vacuum sealing, a desiccant, or the like).

The user can open the packaging 700 to expose the charger 100, which in various embodiments can activate the charger 100 by allowing a chemical reaction to occur within the charger 100 (e.g., a zinc-air reaction as discussed herein). The use can connect the charger 100 to a device 120 via a cable 140, which can allow electrical energy stored or generated by the charger 100 to pass to the user device 120 (e.g., a smartphone). While various embodiments discussed herein relate to providing power from a charger 100 to a user device 120 via a cable 140, some embodiments can comprise wireless power transfer (e.g., inductive power transfer).

Turning to FIG. 27, the user device 120 can be completely or partially charged by the charger 100 in some examples, and the charger 100 in some examples can be disposed of (e.g., recycled, disposed of as trash, or the like). Accordingly, in various embodiments, the charger 100 can be a single use system such that it is configured to only be discharged once and is not configured to be or is unable to be recharged once discharged.

Turning to FIG. 28, an example embodiment of a circuit 2800 to control electrical power from one or more batteries (e.g., one or more cells 240) is illustrated, which comprises a power bus 2810 from one or more batteries (e.g., one or more cells 240), which is operably connected to a low power/voltage monitor 2820 and a voltage regulator 2830. The voltage regulator 2830 is operably connected to a power/current limiter 2840, which can be configured to provide electrical power to one or more user devices 120 such as a smartphone, or the like, via a power line 2850 (e.g., a cable 140). In some embodiments, a PCBA 230 can comprise, or comprise at least a portion of the circuit 2800.

In some embodiments, the circuit 2800 can be configured to prevent, reduce or mitigate excessive power draw from one or more cells 240, prevent, reduce or mitigate heat generated by one or more cells 240 (e.g., that may affect touch-temperature of the charger 100, temperature that may affect performance or lifespan of one or more cells 240, and the like).

The zinc-air cells 240 of a charger 100 in various examples can use ambient air as part of a cathode and thus can require access to air to provide power. If the cells 240 of the charger 100 are starved of air, the charger 100 will not provide a charge or will have undesirably reduced performance in various examples. If air starvation persists, in some examples the cells 240 can convert to a slow-start or no-start starvation mode. A novel electrical circuit (e.g., circuit 2800, PCBA 230, or the like) with a low voltage cut-off and a system to check for current draw can provide a life-saving function for the cells 240. Such a “timed-cutoff” system can force the circuit to check for appropriate parameters (e.g., voltage level) at timed intervals and can shut the pack down in between to preserve the cells. An alternative to a timed-cutoff system can include a microprocessor that programs this function and other suitable devices or systems can be used in further embodiments.

In some embodiments, the circuit 2800 can be configured for low power cut-off, which can be desirable in some examples to prevent end-of-life errant behaviors, prevent starved restart hiccup heating, and the like. For example, in various embodiments, power output of the charger 100 (e.g., to a user device 120) can be disabled for a “time-out” period. In some examples, such a “time-out” period can be a set period of time or can be for a varied period of time based on certain criteria being met or not being met.

For example, where a determination is made that one or more zinc-air cells 240 of a charger 100 are being fully or partially starved of air (e.g., the vents 215 are fully or partially obstructed, which may not be allowing sufficient air to the zinc-air cells 240 to support a suitable reaction to generate sufficient electrical power), power output by the charger 100 can be suspended or reduced for a period of time (e.g., by the circuit 2800, PCBA 230, or the like) until air conditions have reached a suitable state. In another example, where one or more zinc-air cells 240 of a charger 100 are reaching their end of life (e.g., where reactive one or more material of the zinc-air cells 240 have substantially expended or have become less efficient over time of use), power output by the charger 100 can be suspended or reduced for a period of time (e.g., by the circuit 2800, PCBA 230, or the like) until the one or more zinc-air cells 240 are able to generate power in a way that at least meets minimum power output criteria.

In various embodiments, a low power cut-off method can be desirable as it can allow for overall continued operation of the charger 100 (despite temporary stops or reduction in output) even in conditions where the charger 100 is partially or fully starved of air to drive a suitable power output, including when the charger 100 is fresh or over time of use as the power output capabilities of the charger 100 may change over time. An analogy for such a method can be like allowing a swimmer to come up for air so that the swimmer can continue to swim. In contrast, in some embodiments, not allowing for a low power cut-off method can result in conditions where the charger 100 ceases to function completely or for unreasonably long periods of time that provide an undesirable experience for the user instead of providing relatively short power cut-offs that may not even be perceived by a user or may not provide a negative user experience compared to long periods without power or complete failure of the charger 100 to operate.

In various embodiments a low power cut-off method can be implemented in various ways. For example, in some embodiments, a cutoff can be generated at regular timed intervals including automatically at a first regular defined interval during normal operation of the charger 100 with the cutoff being for a second defined amount of time; however, in some embodiments such first and/or second defined amounts of time for intervals between cutoffs and intervals of cutoffs can be varied based on various criteria.

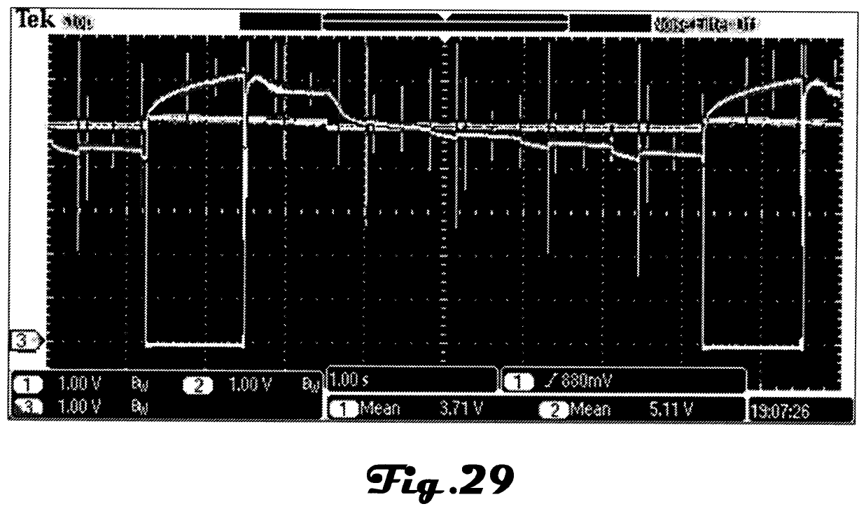

For example, such first and/or second defined amounts of time can be varied based on determined current and/or voltage output by one or more cells 240; determined amount of time the charger 100 has been operating or in existence (e.g., cut-off methods can change over the life of the charger 100 to adapt to expected changes over the life cycle of the charger 100, which may include shelf life and/or operation life); determined based on changing environmental conditions such as a determined amount of air being provided to or available to cells 240 within the charger 100, temperature of the charger 100 and/or cells 240, physical integrity of the cells 240 or other portions of the charger 100, type or characteristics of a user device 120 obtaining power from the charger 100, whether or not a cable 140 and/or user device 120 is plugged into the charger 100, or the like. In various embodiments, a cut-off method can be implemented in various suitable ways such as via software, firmware, or the like, and via systems such as the circuit 2800 a PCBA 230, or the like. One example of a cut-off method is illustrated in FIG. 29.

In some embodiments, a PCBA 230 and/or circuit 2800 can be configured to output electrical power generated by one or more cells 240 to a device 120 (e.g., via a cable 140); monitor the state (e.g., electrical output) of the one or more cells 240; determine, based at least in part on the monitoring, at least one of the one or more cells 240 are air-starved; in response to determining that least one of the one or more cells 240 are air-starved, generate a power cut-off for a period of time that ceases electrical power output by the zinc-air charger 100 (e.g., via the coupling plug of the PCBA), and after the period of time has elapsed or in response to determining that the one or more cells 240 are no longer air-starved, resume output of electrical power generated by one or more cells 240 to the device 120 (e.g., via the cable 140). As discussed herein, in some embodiments, “air-starved” can include one or more zinc-air cell not receiving a suitable amount of air (e.g., oxygen) to support a zinc-air reaction at or above desired power output levels, or other criteria.

Where a circuit board (e.g., circuit 2800 a PCBA 230, or the like) is attached to the cells 240, in some embodiments a small amount of parasitic drain can stimulate a chemical reaction in the cells 240 (e.g., a zinc-air reaction) and can drain the cells 240. In some examples, a pack of one or more cells 240 can read as an open circuit to prevent parasitic drain. Such an open circuit can be implemented in various suitable ways including by using sensing pins on the connector to indicate to the pack that a cable is connected upon insertion. Cable insertion can act as a switch to complete the circuit in some embodiments.

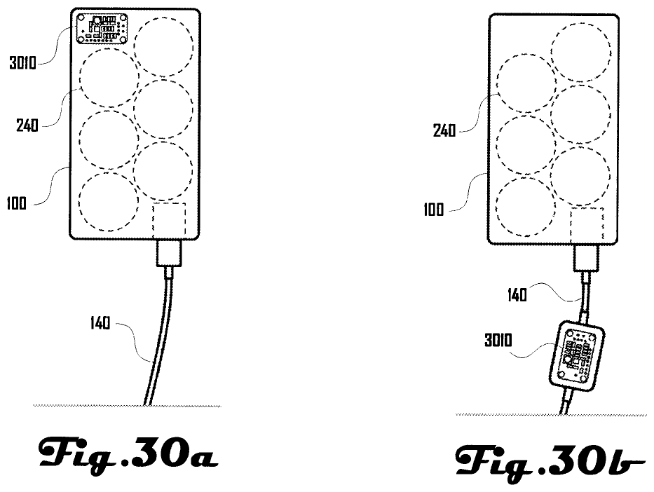

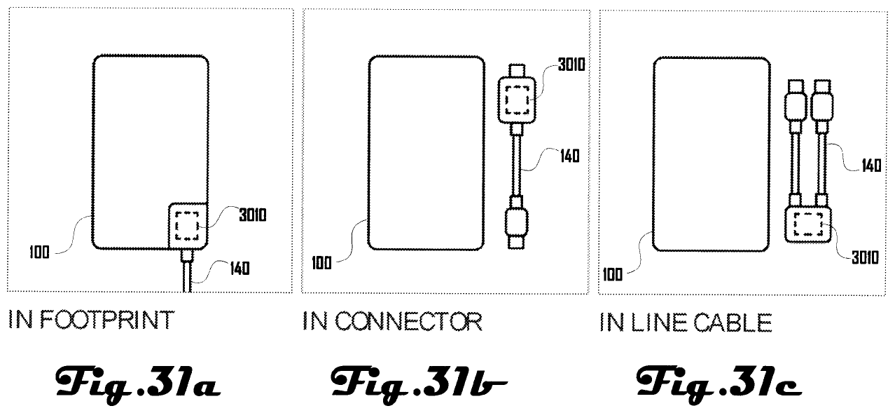

Alternate or additional methods to eliminate or reduce parasitic drain in some examples can include: the circuit being disposed in the cable 140 such that the circuit is fully disconnect from the charger 100 when the cable 140 is not plugged into the charger 100; a pull tab or ground closing tab to put the circuit in a low power state; an external switch where the user can press a button to “close” the circuit and activate the cells. For example, FIGS. 30a and 31a illustrate an example embodiment of a charger 100 where a circuit 3010 is disposed within a charger 100 or at least within the footprint of a charger 100. FIGS. 30b, 31b and 31c illustrate example embodiments where the circuit 3010 is disposed within a cable 140 that is coupled to the charger 100 instead of the circuit being disposed within the charger 100. FIG. 31b illustrates an embodiment where the circuit 3010 is disposed in a connector of the cable 140, and FIG. 31c illustrates an embodiment where the circuit 3010 is disposed in-line within the cable 140.

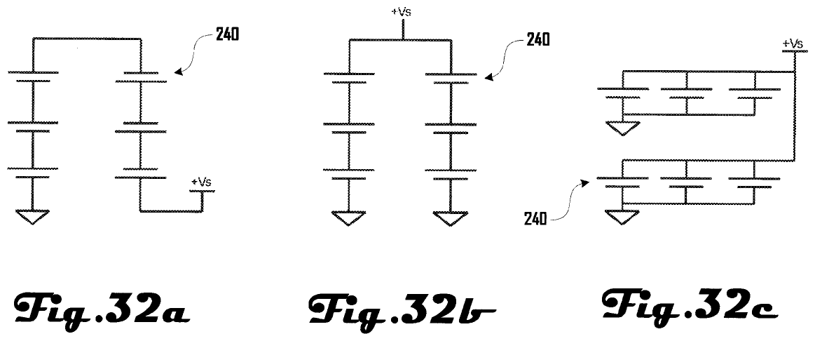

As discussed herein, a charger 100 can comprise any suitable plurality of cells 240, which can be arranged in various suitable ways. For example, FIG. 32a illustrates an embodiment having six cells 240 disposed in series (e.g., a 6S configuration). In some embodiments, such a configuration can be desirable by allowing for a buck-only charger, easy wiring with few components, high potential efficiency, and the like.

FIG. 32b illustrates another example embodiment having six cells 240 in a 3S2P configuration where a first and second set of three cells 240 are in series with the first and second sets of cells 240 being in parallel. Such a configuration can be desirable in some embodiments by allowing two protection components, tolerance to a faulty cell 240, and the like.

FIG. 32c illustrates a further example embodiment having six cells 240 disposed in parallel (e.g., a 6P configuration). Such a configuration can be desirable in some embodiments by allowing a boost-only charger, tolerance to a faulty cell 240, and the like.

The examples of FIGS. 32a, 32b and 32c should not be construed to be limiting, and further embodiments can include similar configurations of any suitable plurality of cells 240, including 2S, 3S, 4S, 5S, 6S, 7S, 8S, 9S, 10S, 15S, 20S, 25S, 50S, 100S, 2P, 3P, 4P, 5P, 6P, 7P, 8P, 9P, 10P, 15P, 20P, 25P, 50P, 100P, 2S3P, 2S4P, 2S4P, 3S2P, 3S3P, 3S4P, 4S2P, 4S3P, 4S4P, and the like. Additionally, a set of cells 240 having a plurality of parallel sets of cells 240 in series can have parallel sets of cells 240 with the same number of cells in the sets 240, or the parallel sets can have different numbers of cells 240 in series.

Turning to FIG. 33, an example embodiment of a charger 100 is illustrated that comprises a battery set 3310 having six cells 240 in series (6S) that is coupled to a protection diode 3320 and regulator 3330 in series. The charger 100 of FIG. 33 is further shown comprising charge current set resistors 3340 that are operably coupled to a connector 235 (e.g., a USB connector, or the like). As discussed herein, further embodiments of a charger 100 can have a battery set 3310 with any suitable number of cells 240 in any suitable combination such as in series, in parallel or a combination thereof. Additionally, cells 240 can be configured in any suitable way with various suitable connectors 235 being employed. For example, FIG. 34 illustrates a plurality of different embodiments of chargers 100 having a different number of cells 240, connectors 235 and configurations thereof.

Some zinc-air cells 240 can include the use of a welded woven or expanded metal grid outside of the cathode material being connected to the cathode can by a metal grid welded to the cathode can being pressed between the cathode can and the cathode disk. However, in some examples, such a method over time can have a decrease in electrical connection as there is not a permanent and constant constraining force to keep the two members in contact because the cathode layer in contact with metal is expanding and contracting during use, which can lead to separation of the two. An elastic and compressive conductive layer like carbon felt/foam/pliable paper can provide a permanent and secure contact because this conductive layer can expand and retract with the cathode as needed. These materials can be very conductive.

Additional zinc-air cells 240 can include the use of an annular ring in the cathode can which presses into the cathode material but still makes use of an external welded woven or expanded metal grid for electrical contact between the cathode can and the cathode material. As with the previous case, the electrical connection can, over time, decrease due to a loss of constraining pressure in some examples. In addition, this embodiment can cause, in some examples, the cathode to bow away from the wire mesh grid resulting in a decreased anode cavity which provides a decreased cell capacity.

Some embodiments can comprise a zinc-air battery cell 240 having a cathode assembly that includes the following layers in the following order: separator—cathode active layer—cathode conductive layer—conductive diffusion pad. The cathode active layer can comprise PTFE, carbon and manganese dioxide (or transitional metal oxides). A nickel mesh can be embedded in the cathode layer and in some examples, the mesh is preferably positioned away from the separator. The purpose of the cathode active layer can be to enable an Oxygen Reduction Reaction (ORR), which generates electrical energy. The cathode active layer can have a mix of both hydrophobic and hydrophilic properties. The cathode active layer can allow air diffusion and can be electrically conductive. The cathode conductive layer, in some examples, contains no transition metal oxide and/or only contains PTFE and carbon. PTFE content in various embodiments can be higher in the cathode conductive layer than the cathode active layer. In various examples, the cathode conductive layer can be totally or substantially hydrophobic and enables electronic conduction and air diffusion. The conductive diffusion pad can sit between a cathode can and the cathode conductive layer. In some examples, the conductive diffusion pad can comprise carbon foam, felt or paper. In some examples, the conductive diffusion pad can comprise a nickel mesh grid, foam or expanded metal welded to the cathode can, or the like.

Some embodiments can relate to high-power performance and the reduction of performance variability that can exist in some zinc-air cells 240. Various embodiments relate to high-power single use zinc-air cells 240. “High-power” in various embodiments, and for some portable applications, can utilize a zinc-air cell 240 and/or charger 100 that achieves continuous areal power capability of equal or greater than 50 mW/cm². Various examples can define a reaction area of a battery product as the interfacial area between the zinc anode and air cathode.

In various embodiments, presence of a mesh in the cathode is combined with the use of a conductive diffusion layer. The role of the mesh embedded in the cathode can change from its traditional role of cathode conductor in the radial plane to more that of a structural support that allows that cathode to be made with more consistency and more cohesion.

In some embodiments, the number of holes in a zinc-air cell 240 can be over 5 per cm² and the hole diameter can be equal or greater than 0.5 mm. The holes can be arranged in a pattern so that no hole is further than 5 mm from the hole closest to it or from the edge of the air cathode.

In further embodiments, the cell 240 can be permitted to bulge by between 5-25%, which can be as a result of a high-power (e.g., 50-135 mW/cm²) discharge reaction. This can allow a reduction of the void volume in a cell 240 and can promote better anode consistency, connectivity with the anode current collector and an increase in the overall anode capacity.

In various embodiments, such aspects separately and/or together can improve the high-power performance of primary zinc-air cells 240. Such a cell 240 in some examples can provide performance benefits to small (portable) rechargeable devices such as a cell phone charger 100 as discussed herein.

Various embodiments can lead to a higher more consistent cathode running voltage and a zinc anode that is less susceptible to passivation and premature failure. In some examples of a zinc-air product these can be experienced in a device as either: More power (W) capability for a given run time, more run time for a given power drain, or combinations thereof.

Turning to FIG. 35, various embodiments can include zinc-air battery cell assembly 240 that comprises a cathode can 3520 made of a metallic material compatible with the electrochemistry of the cell assembly 240 as discussed in more detail herein. The material of the cathode can 3520 can comprise nickel-plated steel in some embodiments. The cathode can 3520 can comprise a plurality of holes 3560 defined by a bottom planar base 3521 of the cathode can 3520 which can allow air passage into the zinc-air battery cell assembly 240 at a calculated rate, which can produce a redox reaction that generates an electrical circuit within the zinc-air battery cell assembly 240.

The zinc-air battery cell assembly 240 can also comprise an anode can 3510, which can be made of a metallic material. The anode can 3510 in some examples can comprise, consist essentially of or consist of a tri-layer material containing a copper layer, a steel layer and a nickel layer. In another embodiment, the anode can 3510 can comprise, consist essentially of or consist of a bi-layer material having a copper layer and a stainless-steel layer with the copper layer being an internal surface and in contact with or facing an anode material 3540 disposed within a cavity 3580 defined by the anode can 3510 and cathode can 3520.

A grommet 3530 can surround the anode can 3510 that can be made of a thermoplastic material coated with styrene-butylene-styrene block copolymer (SBS) or styrene-butadiene copolymer (SBR) compatible with the electrochemistry of the zinc-air battery cell assembly 240. In one embodiment, the grommet 3530 can comprise, consist essentially of or consist of a polypropylene homo-polymer. Polyamide materials can also be used for the grommet 3530 in some embodiments, and in other sealant applications, the material of the grommet 3530 can also be a polyamide-based material such as Versamid (Huntsman Advanced Materials, The Woodlands, Tex.). In various embodiments, the mechanical design of a zinc-air battery cell assembly 240 can specify the style of sealant that is desirable for ensuring appropriate compatibility with an electrolyte of the anode material 3540, the gasket material and the manufacturing methods used for application of the sealant.

The anode material 3540 can be contained within the cavity 3580 defined by the anode can 3510 and cathode can 3520, which in some examples can comprise, consist of, or consist essentially of zinc, aqueous potassium hydroxide, zinc oxide and gelling agents in an aqueous slurry. While a slurry anode material 3540 is desirable in some embodiments, zinc-air battery cell assemblies 240 of some examples can be made using a poured anode process. Even distribution of the anode material 3540 within the cavity 3580 can be desirable in various embodiments.

In some embodiments, if a zinc-air battery cell assembly 240 is discharged at a low rate, high utilization may be required by the zinc-air battery cell assembly 240. In such embodiments, providing a significant void volume in the cavity 3580 of the zinc-air battery cell assembly 240 can be desirable (e.g., 30% utilized). For example, FIG. 35 illustrates an example of a zinc-air battery cell assembly 240 having a void volume 3581 in the cavity 3580 of the zinc-air battery cell assembly 240 between the anode material 3540 and a top end 3511 of the anode can 3510. In some embodiments, current density on the anode material 3540 can be >60 mA/cm² for a high-power drain, which in some examples can cause the zinc-air battery cell assembly 240 to achieve a zinc utilization of 50% or less.

In some embodiments, a 15% void volume 3581 can be desirable, with the void volume 3581 being defined as the amount of space remaining in the cavity 3580 of the zinc-air battery cell assembly 240 aside from components such as the anode material 3540, cathode material 3550, and the like disposed within the cavity 3580 in the assembled zinc-air battery cell assembly 240. In some embodiments, a desirable high-power capability is enabled in a zinc-air battery cell assembly 240 with a void volume 3581 between 15-30% that generates a zinc utilization between 30% and 80%. In further embodiments, the void volume can be 5-40%, 10-35%, 20-25%, 10-20%, 5-25%, and the like.

In yet another aspect, the zinc-air battery cell assembly 240 can be configured to bulge, which can be as a result of expansion of the anode material 3540 and/or cathode material 3550 during a discharge reaction of the zinc-air battery cell assembly 240. For example, such bulging can occur in some embodiments during a high-power discharge reaction, which may include a power discharge of 50-135 mW/cm², 50-100 mW/cm², 50-75 mW/cm², 50-150 mW/cm², 75-135 mW/cm², 100-135 mW/cm², and the like.

Various embodiments relate to single use zinc-air battery cell assembly 240, where “single use” can be defined as a zinc-air battery cell assembly 240 configured for only being discharged once without the ability to re-charge the zinc-air battery cell assembly 240 after being discharged. For example, in various embodiments, a reaction that generates power can be a one-way reaction such that the reaction cannot be suitably reversed such that the zinc-air battery cell assembly 240 can be recharged. In various embodiments, this can be distinguished from a rechargeable battery that only has a limited recharging lifespan and the specific situation where such a battery is discharged for a final time and becomes inoperable.

In various embodiments, the zinc-air battery cell assembly 240 can be configured to bulge (e.g., increase its thickness at a maximum point) to at least between 5-25%, which in some examples can be defined as a volume displacement of the zinc-air battery cell assembly 240 from a normal configuration (e.g., as shown in FIG. 35, where the anode and cathode cans 3510, 3520 are generally planar on the top and bottom of the zinc-air battery cell assembly 240). For example, bulging of the zinc-air battery cell assembly 240 can include outward bulging of the top end 3511 of the anode can 3510 and/or outward bulging of the base 3521.

In some examples, having the zinc-air battery cell assembly 240 configured to bulge to at least a certain amount can be defined as an amount of bulge that the zinc-air battery cell assembly 240 is able to sustain without being damaged, breaking, or the like (e.g., where seals are broken, the anode and cathode cans 3510, 3520 break apart, contents within the zinc-air battery cell assembly 240 come out of the cavity 3580, etc.). In some examples, having the zinc-air battery cell assembly 240 configured to bulge to at least a certain amount can be defined as an amount of bulge that the zinc-air battery cell assembly 240 is able to sustain while still being capable of returning to an original shape (e.g., the anode and/or cathode cans 3510, 3520 can deform while bulging, but can return to an original configuration when bulging is not present). In further embodiments, the zinc-air battery cell assembly 240 can be configured to bulge an amount from 0-5%, 0-10%, 0-15%, 0-20%, 0-25%, 0-30%, 0-35%, 0-40%, 0-45%, 0-50%, and the like.

In some embodiments, expansion of contents within the cavity 3580 (e.g., anode material 3540 and/or cathode material 3550) can result in a reduction of the void volume 3581 in a zinc-air battery cell assembly 240, which in some examples can promote better anode consistency, connectivity with an anode current collector and an increase in overall anode capacity. Additionally, a void volume 3581 in the cavity 3580 can be desirable because it can allow for expansion of the contents within the cavity 3580 (e.g., anode material 3540 and/or cathode material 3550), which in some examples may remove or reduce the amount of bulge that the zinc-air battery cell assembly 240 needs to accommodate. Accordingly, the volume of the void volume 3581 can be configured based at least in part on an anticipated expansion of contents within the cavity 3580 (e.g., anode material 3540 and/or cathode material 3550).

In various embodiments, a volume of anode material 3540 to be present in the cavity 3580 of the zinc-air battery cell assembly 240, and therefore the total weight of the anode material 3540, can be determined initially based at least in part on the volume of the cavity 3580 that will be generated in an assembled zinc-air battery cell assembly 240. Such a volume of the cavity 3580 can be selected based at least in part on the mechanical design of the zinc-air battery cell assembly 240, and components thereof, and making appropriate allowances for the separator and its electrolyte absorption. In some specific embodiments, the anode material 3540 can have a volume of 2.96 cc, or a volume between 3.0 and 2.9 cc, 3.5-2.5 cc, and the like.

The anode material 3540 can be wet (e.g., have a high weight ratio of electrolyte:zinc) in various examples, and in some examples, wetter than embodiments that run between 75-80% zinc weight %. Sealing can accommodate this in some embodiments. For example, in some embodiments the zinc weight % can be between 60-70%, 60-66%, 55-75%, 58-%72%, or the like. Use of a zinc-air developed zinc powder from EverZinc (EverZinc Canada, Quebec, Canada) or Grillo (Grillo-Werke AG, Duisburg, Germany) is preferred in some embodiments, using zinc material used by Alkaline Button or Cylindrical Cell Company may be desirable in some examples. A caustic electrolyte containing potassium hydroxide can be used in some embodiments (e.g., 35% KOH and 2% ZnO, or a range of 33-37%, 30-40% or 25-45% KOH and 1-5%, 1-4% or 1-3% ZnO).

In some embodiments the anode material 3540 can comprise a slurry or gelled composition using sodium polyacrylate of polyacrylic acid as the gellant (e.g., Carbopol 940 NF Polymer, Lubrizol Corporation, Wickliffe, Ohio). The zinc weight % in the slurry can, in some such embodiments, be 64% to 74% or 62% to 74% for best results in some examples and the KOH concentration of the electrolyte can be between 33-37%, 30-40% or 25-45%. The electrolyte of the anode material 3540 may also contain zinc oxide and organic inhibitors in some embodiments, such as Polyethylene Glycol (PEG), Crown 18-6 or inorganic inhibitors such as indium hydroxide.

Carboxymethyl cellulose (CMC) can be used as an anode expander (e.g., in a poured anode process). High molecular weight, cross-linked polyacrylic acid polymers (e.g., Carbopol) can be used as an anode expander (e.g., in a slurry anode process). High (e.g., up to 2%) CMC content in the anode material 3540 can help with cell wetness in some embodiments and the balance between the separator and CMC absorption of electrolyte can be tuned. In some embodiments, the type of zinc used in the anode material 3540 can be an appropriate alloy with small amounts of zinc gassing inhibitors. For example, in some embodiments, individual alloying components can be less than 500 ppm and can include indium, bismuth calcium, aluminum, mercury, lead, or the like.

Packing density (e.g., particle-particle contact) can be an important variable in various embodiments. In some examples, a large diameter (e.g., greater than 500 microns) can produce problems such that a small cone of zinc becomes unreacted in the center of the zinc-air battery cell assembly 240. Distribution of the anode material 3540 can be important in some embodiments, and if a poured anode material 3540 is used, multiple pouring holes may be required in some examples. Alternatively, a method of manufacturing a zinc-air battery cell assembly 240 may employ a rotating fixture to ensure even filling of anode material 3540 within the cavity 3580 of the zinc-air battery cell assembly 240.

It can be desirable for gassing rates of the anode material 3540 to be low in some embodiments (e.g., less than 0.5 cm³ after 1 week at 60° C.). In various embodiments, contaminants can be managed in some or all components to current zero added mercury (Hg) zinc-air cells. Corrosion inhibitors can be dissolved in an electrolyte of the anode material 3540 to reduce zinc gassing. Polyethylene Glycol (PEG) can be used for this purpose in some examples. Crown 18-6 (1,4,7,10,13,16-hexaoxacyclooctadecane) can be effective for reducing zinc gassing and can be added in some examples at a level of between 200-2500 ppm, 100-3500 ppm, 250-2000 ppm, 300-1500 ppm by weight of electrolyte, and the like. Note that as discussed herein, the terms “zinc corrosion” and “gassing,” or the like, can be synonymous in various examples.

In various embodiments, zinc corrosion can be maintained at a low level. A corrosion rate at 60° C. of less than 0.2%/g/week or gas evolution rate of less than 0.04 micro-liter/g/week can be desirable in some examples. Higher corrosion/gassing rates in some embodiments can lead to leakage, cathode flooding, gas collection between the cathode and separator, gas collection between the separator and anode and/or ion impeding gas bubbles trapped in the zinc gel/slurry.

Various examples of aqueous alkaline batteries that have zinc anodes (e.g., anode material 3540) can be configured to manage and control the corrosion of zinc that results in the production of hydrogen gas within the battery. While this can be undesirable in various types of batteries, a zinc-air battery cell assembly 240 in various embodiments can be particularly sensitive in some examples that have an open design and access to air. Problems that can result in some examples can include leakage, cathode flooding, separation of components and particularly deleterious for high-power performance in some examples, the collection of gas bubbles within the anode material 3540 that can lead to impedance and uniform zinc discharge issues.

Gassing management can be achieved in various embodiments by the use of alloying components in the zinc of anode material 3540, a focus on material purity and/or by plating of an anode conductor. In addition, the use of an organic inhibitor can be added to an electrolyte of the anode material 3540, and in some embodiments, this can reduce the gassing reaction while at the same time not interfering with the battery discharge reaction. Many suitable types of inhibitors can be used in embodiments of aqueous alkaline batteries including Polyethylene Glycol, Non-ionic Alkyl and/or Aryl Phosphate surfactants, for example, RA-600, Sodium dodecylbenzenesulfonate, for example, Witconate, and different Polyamines. Each of these chemicals in various examples may be able to dissolve in an alkaline electrolyte, may be chemically stable in a zinc-air battery cell assembly 240, may adsorb onto the zinc surface, but may not impede the electrochemical oxidation of the zinc or the distribution of oxy-zinc products.

This disclosure in one aspect relates to a series of organic ring molecules called Crown Ethers that can act as complexing agents in various embodiments and may be able, depending on their structure, to trap different cations. In one preferred embodiment, 0.2 weight percent of 18-Crown-6 is added to an alkaline electrolyte, while further embodiments can include 0.15-0.25 or 0.1-0.3 weight percent of 18-Crown-6. Tests of an implementation having 0.2 weight percent of 18-Crown-6 show that, at this level, zinc corrosion of the zinc-air battery cell assembly 240 can be reduced versus other inhibitors and that the high-power performance is improved. 18-Crown-6 can be best for potassium-based alkaline electrolytes in some examples, but other Crown-style inhibitors can have efficacy and moreover can, in some examples, be better suited for sodium or lithium hydroxide systems or electro-chemistries that have a different anode than zinc.

The following Crown Ethers can be used in some embodiments and an electrolyte concentration of between 0.05 weight % and 0.5 weight % can be desirable in various examples: 18-Crown-6, 15-Crown-5, 12-Crown-4, Diaza-18-Crown-6, Di-Benzo-18 Crown-6, Diazacrowns, Cryptands, Azo-Crowns, Lariats, and the like. Some embodiments can have an electrolyte concentration of between 0.05-0.5 weight %, 0.05-1.0 weight %, 0.05-1.5 weight %, 0.1-0.45 weight %, 0.15-0.40 weight %, 0.2-0.35 weight %, 0.25-0.30 weight %, and the like.

Located between the anode material 3540 and the cathode material 3550 can be a separator 3590, which in some examples can act as both an electronic insulator and an ion conductive path. In various embodiments, a separator 3590 in a zinc-air battery cell assembly 240 (e.g., a high-power single-use zinc-air battery) can provide electronic insulation between the anode material 3540 and the cathode material 3550, but at the same time, provide for low resistance ionic conduction. The balancing act between the two may not be easy to achieve in various examples, and for a zinc-air battery cell assembly 240, in various embodiments it can be desirable for the separator to have the added property of reducing and managing the transfer of Oxygen (O₂), Water vapor (H₂O) and/or Carbon Dioxide (CO₂). This can be important for some example applications of a zinc-air battery cell assembly 240 that can have run times measured in days, weeks or even months as both O₂ and CO₂ may pass through the separator 3590 and may degrade the zinc and electrolyte of the anode material 3510 given enough time. Separators for high-power and/or low-power batteries may not need low wet ionic resistance to deliver the required level of performance and such separators may be characterized by small pore size to minimize gas transfer. For example, a zinc-air battery cell assembly 240 in some examples can comprise one or more separators having pore sizes less than 1 micron and wet ionic resistances of higher than 50 mohm·cm². In some embodiments, a separator can have a pore size of less than 10, 9, 8, 7, 6, 5, 4, 3, 2, 1, 0.75, 0.5, 0.25 microns, or the like. In some embodiments, a separator can have wet ionic resistances of higher than 100 mohm·cm², 75 mohm·cm², 50 mohm·cm², 25 mohm·cm², and the like.

In some examples of a high-power zinc-air battery cell assembly 240, such as a cell phone charger, the zinc-air battery cell assembly 240 can deliver practical energy between 1-10 hours which may be insufficient time for deleterious gas transfer across the separator 3590 to cause an unacceptable decrease in the performance of the zinc-air battery cell assembly 240. It is therefore possible, in some embodiments, for such an application to open up the pore size and/or increase the overall porosity of the separator 3590, which can generate a benefit from a reduced wet ionic resistance without causing an unacceptable decrease in the performance of the zinc-air battery cell assembly 240 due to gas transfer across the separator 3590 given expected operation time and/or one-use nature of such a zinc-air battery cell assembly 240.

An implementation of one example embodiment of a zinc-air battery cell assembly 240 a separator 3590 included two layers of a PVA-Cellulosic separator supplied by SWM (Schweitzer-Mauduit International). This material had the following properties: Basis Weight: 20.5 g/m²; Thickness: 60-70 microns; Absorption: 115 g/m²; Mean Pore Size: 2.20 microns; and Maximum Pore Size: 9.80 microns. When this configuration was tested in a zinc-air battery cell assembly 240 at a rate of 70 mW/cm², the example separator 3590 in this example embodiment outperformed separators 3590 with smaller pore size and higher wet ionic resistance.

One preferred embodiment can include a separator 3590 comprising PVA fibers blended with synthetic or natural cellulose using the dry-laid or wet-laid process. Surfactants can also be added to improve the properties of the separator. Other separator compositions can include Polyolefin, Polyamide, Polyester, Polysulfone and Wood Pulp.

In various embodiments, high power can be maximized for a zinc-air battery cell assembly 240 without deleterious gas transfer across the separator 3590 when the mean pore size is between 1 and 10 microns and when the wet ionic resistance for the separator system (e.g., one or more layers) is less than 50 mohm·cm². Some embodiments can have a mean pore size between 1 and 20 microns, between 1 and 15 microns, between 1 and 5 microns, and the like. In some embodiments, wet ionic resistance can be less than or equal to 100 mohm·cm², 75 mohm·cm², 50 mohm·cm², 25 mohm·cm², and the like.

The cathode material 3550 can be in direct contact with the cathode can 3520 and can be comprised of a carbon-polymer composite in some examples. In some examples, a metal oxide catalyst can be added to the cathode material 3550 to aid an oxygen reduction reaction. Located within the area between the planar base 3521 of the cathode can 3520 containing the air access holes 3560 and a planar rim 3522 in contact with the cathode material 3550 can be an air diffusion member 3570. This air diffusion member 3570 can be a primary means of conduction of electrical charge between the cathode material 3550 and the cathode can 3520 in various embodiments. The air diffusion member 3570 in some examples can be made of various suitable materials such as a carbon foam, carbon felt, carbon paper material, or the like. In some embodiments, the conductive diffusion member 3570 can have a porosity of greater than 60% and an electronic resistivity of less than 20 mohm-cm. In some embodiments, the conductive diffusion member 3570 can have a porosity or open area of greater than 40%, 45%, 50%, 55%, 60%, 65%, 70%, and the like.

While some examples can include non-woven diffusion member 3570, some embodiments can comprise a diffusion member 3570, a nickel mesh diffusion pad 3570 (e.g., a nickel mesh diffusion pad is used instead of a non-woven diffusion pad). Such embodiments can provide desirable contact between the cathode material 3550 and the cathode can 3520 across the entire or a large portion of the surface area of the cathode material 3550. Some embodiments can comprise several (e.g., 4, 6, 8, 10, or the like) spot welds or laser welds to ensure good electrical contact with the cathode can 3520. In various examples, it can be desirable for a nickel diffusion pad to not interfere with air flow and/or be chemically reactive with the composition of the zinc-air battery cell assembly 240.

In various examples, it can be desirable for the anode can 3510 to not promote excessive zinc gassing when in contact with zinc and electrolyte that may comprise the anode material 3540. Accordingly, in some embodiments, it can be desirable for metal components such as the anode can 3510 and/or cathode can 3520 to comprise pure copper, brass, tin or indium plating, or the like. For example, tin plating of the whole of the anode can 3510 can be present in some embodiments. Various examples can include welding to or cladding with tin plate.

One aspect of the present disclosure includes an air cathode assembly that can comprise, consist of, or consist essentially of a multiple layer assembly (e.g., 0.4 mm+/−0.04 mm thick), which can be circular in shape with a diameter corresponding to the size of a cathode can 3520 as discussed herein.

FIG. 36 illustrates a cross-sectional view of an example of an air cathode assembly 3600 in accordance with one embodiment, which can comprise, consist of, or consist essentially of a first conductive cathode diffusion layer 3610, a grid 3620 disposed in a second active air cathode layer 3630 and a third separator layer 3640. In the example of FIG. 36, the second active air cathode layer 3630 is sandwiched between, directly adjacent to and bonded to the first conductive cathode diffusion layer 3610 and the third separator layer 3640, without any intervening layers.

In various examples, first conductive cathode diffusion layer 3610 can comprise, consist of, or consist essentially of a conductive microporous polymer layer bonded to the second active air cathode layer 3630. In some embodiments, the first conductive cathode diffusion layer 3610 can comprise a carbon containing polytetrafluoroethylene (PTFE). Electronic conduction in both layer 3610 and layer 3630 can be into and out of the plane. In some embodiments, the thickness of the conductive cathode diffusion layer 3610 can be between 0.1 and 0.3 mm. In some embodiments the thickness of the active air cathode layer 3630 can be between 0.2 and 0.6 mm.

In various examples, the grid 3620 can comprise, consist of, or consist essentially of a nickel mesh that may or may not be coated with carbon or graphite paint (e.g., coated with Timrex Graphite and/or Dispersions, Imerys Graphite & Carbon Switzerland SA or coated with Acheson graphite paint, or the like). In some embodiments, the grid 3620 may or may not be coated with carbon or graphite paint and fixed to the inside of a cathode can 3520 with a conductive glue such as MG Chemicals Super Silver Epoxy adhesive, spot welding, laser welding, or the like.

The grid 3620 can be embedded into the second active air cathode layer 3630 and can provide stability and high-power performance consistency in some examples. In various embodiments, the grid 3620 can be defined by a plurality of elongated grid elements 3621 disposed in a plurality of parallel rows and parallel columns, with the rows and columns being perpendicular to each other and engaging at a plurality of intersections. For example, FIG. 36 illustrates a cross-section with a plurality of grid elements 3621 disposed in parallel and embedded in the second active air cathode layer 3630. As shown in FIG. 36, the grid 3620 can be planar with a plane of the grid 3620 being parallel to respective planes of contact between the active air cathode layer 3630 and the conductive cathode diffusion layer 3610 and the separator 3640. In some embodiments, the grid elements 3621 can comprise nickel, nickel alloys, nickel plated steel, and the like. In some embodiments, thickness of grid elements can be 0.05-0.25 mm. Distance between grid elements can be expressed as % open area and can be 60% to 90% in some examples.

Additionally, as shown in the example of FIG. 36, the grid 3620 can be disposed within the second active air cathode layer 3630 proximate to the conductive cathode diffusion layer 3610 or disposed closer to the conductive cathode diffusion layer 3610 compared to the separator layer 3640. In other words, the second active air cathode layer 3630 can have a central plane and the grid 3620 can be disposed within the second active air cathode layer 3630 on one side of the central plane closer to the conductive cathode diffusion layer 3610. In some embodiments, the grid 3620 can be flush with the conductive cathode diffusion layer 3610. For example, the grid 3620 can be disposed at an external edge of the second active air cathode layer 3630 such that the grid 3620 can engage with or directly abut the conductive cathode diffusion layer 3610.

The size, position and configuration of the grid 3620 illustrated in FIG. 36 is provided as one example; however, in further embodiments the grid 3620 can have any suitable size, configuration or position relative to layers 3610 and 3640. For example, in some embodiments, the grid 3620 can comprise a plurality of circular rings of various diameters with a plurality of radial grid elements extending radially from a central location of the grid. Also, while some embodiments can comprise a grid 3620 defining square or rectangular spaces between rows and columns of grid elements 3621, further embodiments can include a grid 3620 including spaces of one or more suitable shape, including triangular, pentagonal, hexagonal, heptagonal, octagonal, or the like. Additionally, grid elements 3621 may not be linear or elongated in various embodiments.

In some embodiments, the grid 3620 may or may not provide an electric conduction and connection through its circumference to the cathode can 3520 of the zinc-air battery cell assembly 240 (see, e.g., FIG. 35) that the cathode assembly 3600 is disposed in. For example, in some embodiments, one or more ends of grid elements 3621 can engage the cathode can 3520 of a zinc-air battery cell assembly 240 to generate an electrical connection between the grid 3620 and the cathode can 3520 of the zinc-air battery cell assembly 240. In further examples, the grid 3620 can comprise a peripheral rim or other suitable element that allows the grid 3620 to engage with and have an electrical connection with the cathode can 3520 of the zinc-air battery cell assembly 3640. However, it should be clear that in various embodiments, electrical and/or physical contact (e.g., radially) between the grid 3620 and cathode can 3520 is specifically absent.

In some embodiments, an electrical connection between the active air cathode layer 3630 and the cathode can 3520 can be provided by a conductive carbon disk (e.g., conductive diffusion member 3570). In some embodiments, such a conductive disc can comprise a felt, a foam or a paper. Such a conductive disc in some examples can have a thickness between 0.1 mm and 0.25 mm and can have a resistivity of less than 20 mohm·cm². Preferably, in some embodiments, the thickness of the conductive disc can be between 0.1 and 0.25 mm and the conductivity can be between 5 and 15 mohm·cm². The conductive disk may be held in place by pressure between the cathode assembly 3600 or the cathode material 3550 and the cathode can 3520, by adhesive, or the like.

In various embodiments, the second active air cathode layer 3630 can be pressed together to form a contiguous cathode strip and can then be pressed onto a grid 3620 such that the grid 3620 is embedded in the second active air cathode layer 3630. In some examples, the second active air cathode layer 3630 can comprise high-conductivity carbons and/or high-surface-area carbons, and finely dispersed manganese dioxide all mixed together with a dispersion of polytetrafluoroethylene (PTFE) in water. Other methods may use the permanganate method where the carbon is washed with a permanganate solution and then dried in an oven to produce the manganese oxide catalyst.

In various embodiments, the third separator layer 3640 can comprise a 25 μm microporous monolayer polypropylene membrane that is laminated to a polypropylene nonwoven fabric and surfactant coated to a total thickness of about 110 μm. For example, some embodiments of the third separator layer 3640 can comprise Celgard 5550 (Celgard, LLC, Charlotte, N.C.). In some examples, the separator layer 3640 can be glued onto the second active air cathode layer 3630 using various suitable adhesives such as a polyvinyl alcohol (PVA) or polyacrylic acid (PAA) based glue, or the like. Carboxymethyl cellulose (CMC) may be included as a component of the separator layer 3640. In some embodiments, pre-wetting of the separator 3640 can be desirable.

In various embodiments, the separator layer 3640 serves to maximize ionic conduction (e.g., and minimize ionic resistance) and can provide electronic insulation between the anode and the cathode. Ionic conduction in aqueous batteries can be enabled by separator porosity and the presence of conducting electrolyte within the separator pores. In some embodiments, porosity of the separator layer 3640 can be between 75% and 90%. Shorting or puncture resistance can also be important in some examples. In various embodiments, it can be important that the anode and cathode never touch; even when the cell is fresh or during discharge when the anode and cathode expand, and the separator is squeezed between them and when semi-conducting solids can deposit in the pores of the separator layer 3640. Factors that can be important in some examples can be the separator thickness, separator tortuosity and separator mechanical integrity.

In some examples, a cathode assembly 3600 can have a total thickness T of between 0.3 mm and 0.7 mm, and in some embodiments preferably less than 0.45 mm. Further embodiments can include a cathode assembly 3600 having a thickness between 0.1 mm and 0.9 mm, 0.2 mm and 0.8 mm, 0.4 mm and 0.6 mm, 0.5 mm and 0.2 mm, 0.5 mm and 0.3 mm, 0.5 mm and 0.4 mm, or the like.

In some examples, such an air cathode assembly 3600 embodied in a zinc-air battery cell assembly 240 (or other embodiments of a zinc-air battery cell assembly 240 discussed herein) can have a minimum continuous power capability of 60 mW/cm², 70 mW/cm², 80 mW/cm², 90 mW/cm², 100 mW/cm², 110 mW/cm², 120 mW/cm², 130 mW/cm², 135 mW/cm² 140 mW/cm², 150 mW/cm², and the like.

It should be noted that the examples of FIGS. 35 and 36 can be suitably combined in various ways and that the elements of one given example should not be considered to be exclusive to that illustrative embodiment. For example, in one embodiment, the cathode material 3550 of FIG. 35 can comprise, consist of or consist essentially of an active air cathode layer 3630 and the conductive cathode diffusion layer 3610 of FIG. 36. Accordingly, various suitable elements of FIGS. 35 and 36 should be considered interchangeable, or may be specifically absent in some embodiments. For example, the cathode material 3550 of FIG. 35 can be interchangeable with the combined active air cathode layer 3630 and conductive cathode diffusion layer 3610 of FIG. 36. In another example, the third separator layer 3640 of FIG. 36 can be interchangeable with the separator 3590 of FIG. 35. In a further example, the cathode assembly 3600 of FIG. 36 (having an air cathode layer 3630, conductive cathode diffusion layer 3610 and separator layer 3640) can be interchangeable with the cathode material 3550 and separator 3590 of FIG. 35.

The embodiments shown and described are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

What is claimed is:

1. A zinc-air charger consisting essentially of:
a first case portion defining a plurality of pass core vents;
a second case portion coupled with the first case portion, with the coupled first case portion and second case portion defining an internal case cavity;
a plurality of at least five zinc-air cells, the at least five zinc-air cells being cylindrical button cell batteries disposed within the internal case cavity, the at least five zinc-air cells electrically coupled in series via a plurality of conductive strips, the at least five zinc-air cells disposed in a common plane with the at least five zinc-air cells disposed in two columns of two and three zinc-air cells respectively, with a central diameter of first and second cells in the two-column of zinc-air cells being aligned with spaces between respective third, fourth and fifth zinc-air cells in the three-column of zinc-air cells, and with a central diameter of a middle zinc-air cell of the three-column of zinc-air cells being aligned with a space between the first and second zinc-air cells of the two-column of zinc-air cells, with each of the plurality of at least five zinc-air cells comprising:
a cylindrical metal cathode can that includes:
a planar base,
an elongated cathode sidewall that extends perpendicular to a plane of the planar base, the elongated cathode sidewall extending to a terminal cathode sidewall end, and
a plurality of air holes defined by the planar base;
a cylindrical metal anode can that includes:
a planar top end, and
an elongated anode sidewall that extends perpendicular to a plane of the planar top end, the elongated anode sidewall extending to a terminal anode sidewall end, the metal anode can disposed nested within the metal cathode can with the elongated anode sidewall disposed parallel and adjacent to the elongated cathode sidewall;
a cavity defined by the metal cathode can and the metal anode disposed nested within the metal cathode can, the cavity including:
a layer of anode material,
a layer of cathode material, and
a void volume; and
a grommet that provides a seal between the metal cathode can and the metal anode while also keeping the metal anode can and cathode can physically and electrically separate;
a barrier assembly disposed within the internal case cavity between and directly adjacent to the first case portion and the at least five zinc-air cells, the barrier assembly comprising a planar hydrophobic sheet of polytetrafluoroethylene that allows gas to pass through the barrier assembly in and out of the internal case cavity to and from the at least five zinc-air cells, but preventing external liquid from coming into contact with the at least five zinc-air cells and preventing liquid of the at least five zinc-air cells from leaking out of the internal case cavity; and
a PCBA disposed within the internal case cavity, the PCBA comprising a coupling plug with at least a portion of the coupling plug exposed external to the internal case cavity, the coupling plug configured to couple with a cable to provide electrical power to a device connected to the cable,
wherein the PCBA is configured to:
output electrical power generated by the at least five zinc-air cells to the device via the cable,
monitor electrical output of the at least five zinc-air cells,
determine, based at least in part on the monitoring, that one or more of the at least five zinc-air cells are air-starved,
in response to determining that the one or more of the at least five zinc-air cells are air-starved, generate a power cut-off for a period of time that ceases electrical power output by the zinc-air charger via the coupling plug of the PCBA, and
after the period of time has elapsed or in response to determining that the at least five zinc-air cells are not air-starved, resume output of electrical power generated by the at least five zinc-air cells to the device via the cable.

2. A zinc-air charger product assembly comprising: the zinc-air charger of claim 1, wherein the zinc-air charger is vacuum packaged in a sealed package with air being substantially absent from the sealed package such that the at least five zinc-air cells are inoperable to generate electrical power from a zinc-air reaction based at least in part on the air being substantially absent from the sealed package, and
wherein the zinc-air charger is activated, and made capable of generating electrical power via the at least five zinc-air cells, by removing the zinc-air charger from the sealed package and exposing zinc-air charger and the at least five zinc-air cells to air via the plurality of pass core vents of the first case portion.

3. The zinc-air charger product assembly of claim 2, wherein the zinc-air charger comprises a label on a face of the second case portion, the label having a public key, a private key and a QR code,
wherein the private key and the QR code are obscured from view by the sealed package when the zinc-air charger is vacuum packaged within the sealed package, but the public key is visible through a transparent or translucent portion of the sealed package when the zinc-air charger is vacuum packaged within the sealed package, and
wherein the public key, the private key and the QR code are visible to a user when the zinc-air charger is removed from the sealed package.

4. A zinc-air charger comprising:
a first case portion defining a plurality of pass core vents;
a second case portion coupled with the first case portion, with the coupled first case portion and second case portion defining an internal case cavity;
a plurality of zinc-air cells disposed in the internal case cavity in a common plane and electrically coupled in series via a plurality of conductive strips;
a barrier assembly disposed within the internal case cavity between and directly adjacent to the first case portion and the plurality of zinc-air cells; and
a PCBA disposed within the internal case cavity, the PCBA comprising a coupling plug with at least a portion of the coupling plug exposed external to the internal case cavity, the coupling plug configured to couple with a cable to provide electrical power to a device connected to the cable,
wherein the PCBA is configured to:
output electrical power generated by the plurality of zinc-air cells to the device via the cable,
monitor electrical output of the plurality of zinc-air cells,
determine, based at least in part on the monitoring, that one or more of the plurality of zinc-air cells are air-starved,
in response to determining that the one or more of the plurality of zinc-air cells are air-starved, generate a power cut-off for a period of time that ceases electrical power output by the zinc-air charger via the coupling plug of the PCBA, and
after the period of time has elapsed or in response to determining that the plurality of zinc-air cells are not air-starved, resume output of electrical power generated by the plurality of zinc-air cells to the device via the cable.

5. The zinc-air charger of claim 4, wherein the plurality of zinc-air cells are disposed in a common plane with at least four of the plurality of zinc-air cells disposed in two columns, with each of the columns comprising at least two zinc-air cells.

6. The zinc-air charger of claim 4, wherein each of the plurality of zinc-air cells comprise:
a metal cathode can;
a metal anode; and
a cavity defined by the metal cathode can and the metal anode disposed nested within the metal cathode can, the cavity including:
a layer of anode material,
a layer of cathode material, and
a void volume.

7. The zinc-air charger of claim 4, wherein the barrier assembly comprises a planar sheet that allows gas to pass through the barrier assembly in and out of the internal case cavity to and from the plurality of zinc-air cells, but at least inhibits external liquid from coming into contact with the plurality of zinc-air cells and at least inhibits liquid of the plurality of zinc-air cells from leaking out of the internal case cavity.

8. A zinc-air charger product assembly comprising: the zinc-air charger of claim 4, wherein the zinc-air charger is packaged in a sealed package with air being substantially absent from the sealed package such that the plurality of zinc-air cells are inoperable to generate electrical power from a zinc-air reaction based at least in part on the air being substantially absent from the sealed package, and
wherein the zinc-air charger is activated, and made capable of generating electrical power via the plurality of zinc-air cells, by removing the zinc-air charger from the sealed package and exposing zinc-air charger and the plurality of zinc-air cells to air via the plurality of pass core vents of the first case portion.

9. The zinc-air charger product assembly of claim 8, wherein the zinc-air charger comprises a label on a face of the second case portion, the label having a public key, a private key and a scannable code,
wherein the private key and the scannable code are obscured from view by the sealed package when the zinc-air charger is vacuum packaged within the sealed package, but the public key is visible through a transparent or translucent portion of the sealed package when the zinc-air charger is packaged within the sealed package, and
wherein the public key, the private key and the scannable code are visible to a user when the zinc-air charger is removed from the sealed package.

10. A zinc-air charger comprising:
a case defining:
a plurality of pass core vents, and
an internal case cavity;
a plurality of zinc-air cells that are electrically coupled and disposed within the internal case cavity;
a coupling plug configured to couple with and provide electrical power generated by the plurality of zinc-air cells to a device that is separate from the zinc-air charger; and
a system configured to:
output electrical power generated by the plurality of zinc-air cells to the device,
identify a state of the plurality of zinc-air cells,
determine, based at least in part on the identified state of the plurality of zinc-air cells, that one or more of the plurality of zinc-air cells are air-starved, and
in response to determining that the one or more of the plurality of zinc-air cells are air-starved, generate a power cut-off for a period of time that ceases electrical power output to the device.

11. The zinc-air charger of claim 10, wherein the system is further configured to, after the period of time has elapsed or in response to determining that the plurality of zinc-air cells are not air-starved, resume output of electrical power to the device.

12. The zinc-air charger of claim 10, wherein the plurality of zinc-air cells are coupled in series.

13. The zinc-air charger of claim 10, further comprising a barrier assembly disposed within the internal case cavity between and directly adjacent to a first case portion and the plurality of zinc-air cells.

14. The zinc-air charger of claim 13, wherein the barrier assembly comprises a planar sheet that allows gas to pass through the barrier assembly in and out of the internal case cavity to and from the plurality of zinc-air cells, but at least inhibits external liquid from coming into contact with the plurality of zinc-air cells and at least inhibits liquid of the plurality of zinc-air cells from leaking out of the internal case cavity.

15. The zinc-air charger of claim 10, wherein the system comprises a PCBA.

16. The zinc-air charger of claim 10, wherein the plurality of zinc-air cells are disposed in a common plane and arranged in a plurality of columns.

17. The zinc-air charger of claim 10, wherein each of the plurality of zinc-air cells comprise:
a metal cathode can;
a metal anode; and
a cavity defined by the metal cathode can and the metal anode disposed nested within the metal cathode can, the cavity including:
a layer of anode material,
a layer of cathode material, and
a void volume.

18. A zinc-air charger product assembly comprising: the zinc-air charger of claim 10, wherein the zinc-air charger is disposed in a package with air being substantially absent from the package such that the plurality of zinc-air cells are inoperable to generate electrical power from a zinc-air reaction based at least in part on the air being substantially absent from the package.

19. The zinc-air charger product assembly of claim 18, wherein the zinc-air charger is configured to be activated, and made capable of generating electrical power, by removing the zinc-air charger from the package and exposing the plurality of zinc-air cells to air via the plurality of pass core vents.

20. The zinc-air charger product assembly of claim 18, wherein the zinc-air charger comprises a label on a face of case, the label having a public key, a private key and a scannable code,
wherein the private key and the scannable code are obscured from view by the package when the zinc-air charger is vacuum packaged within the package, but the public key is visible through a transparent or translucent portion of the package when the zinc-air charger is packaged within the package, and
wherein the public key, the private key and the scannable code are visible to a user when the zinc-air charger is removed from the package.
